(19) United States
(12) Patent Application Publication
(10) Pub. No.: US 2022/0387878 A1
(43) Pub. Date: Dec. 8, 2022

(54) INFORMATION STORAGE MEDIUM, SERVER, AND GAME SYSTEM

(71) Applicant: CYGAMES, INC., Tokyo (JP)

(72) Inventor: Naoyuki Miyashita, Tokyo (JP)

(73) Assignee: CYGAMES, INC., Tokyo (JP)

(21) Appl. No.: 17/686,137

(22) Filed: Mar. 3, 2022

Related U.S. Application Data
(63) Continuation of application No. PCT/JP2020/033118, filed on Sep. 1, 2020.

(30) Foreign Application Priority Data
Sep. 5, 2019 (JP) 2019-162112

(51) Int. Cl. A63F 1/02; A63F 13/822

(52) U.S. Cl. CPC A63F 1/02; A63F 13/822

(57) ABSTRACT

A card image for a first special card or a card image for a second special card, for which a player input for placing the card in the field is acquired, is removed, and a card image for which a player input for selecting a card as a card to be removed is acquired is removed. Furthermore, as an effect of the first special card or second special card placed in the field, a special lottery for determining two cards from a plurality of kinds of cards corresponding to the class of a player at a local terminal is executed, and the two cards determined by the special lottery are added to the hand of the player at the local terminal.

This application is a continuation of International Patent Application No. PCT/JP2020/33118, having an international filing date of Sep. 1, 2020, which designated the United States, the entirety of which is incorporated herein by reference. Japanese Patent Application No. 2019-162112 filed on Sep. 5, 2019 is also incorporated herein by reference in its entirety.

### BACKGROUND

The present invention relates to information storage mediums, servers, and game systems.

There is a program that has been known heretofore, with which a player constructs a card group by combining a plurality of kinds of cards, and a card game is run on the basis of cards selected by the player from the card group constructed by the player and cards selected by an opponent from a card group constructed by the opponent.

Furthermore, among programs of the type described above, there is a program with which cards that have become unavailable for selection by the player as the game is run are excluded from the card group constructed by the player, thereby making it possible to add specific cards not included in the card group constructed by the player as cards that are available for selection by the player (see Publication of Japanese Patent No. 6369769).

With such a program, an important element of the card game is how the player combines cards to construct a card group. However, there is a problem in that some players feel it difficult or laborious to construct a card group. Furthermore, among programs of the type described above, there is also a program with which a player is allowed to select a card group from a plurality of kinds of different predefined card groups. However, there is a problem in that, depending on the combination of the card group selected by the player and the card group selected by the opponent, advantages and disadvantages arise even before the game is run.

### SUMMARY

The present invention has been made in view of the situation described above, and it is an object thereof to provide a non-transitory computer-readable information storage medium storing a program, a server, and a game system that make it possible to appropriately run a game, while allowing players to casually play the game.

According to a first aspect of the invention, there is provided a non-transitory computer-readable information storage medium storing a program for running a game on the basis of game media included in a game medium group associated with a player and game media included in a game medium group associated with an opponent, the program causing a computer to function as:

a type processing unit that associates one of a plurality of types with the player;

a game-medium-group processing unit that associates a game medium group including a plurality of special game media with the player; and

a game-medium processing unit that determines a game medium from the game medium group corresponding to the type associated with the player and adds the determined game medium to the game medium group associated with the player in the case where a special condition corresponding to a special game medium is satisfied.

According to a second aspect of the invention, there is provided a server for running a game on the basis of game media included in a game medium group associated with a player and game media included in a game medium group associated with an opponent, the server including:

a type processing unit that associates one of a plurality of types with the player;

a game-medium-group processing unit that associates a game medium group including a plurality of special game media with the player; and

a game-medium processing unit that determines a game medium from the game medium group corresponding to the type associated with the player and adds the determined game medium to the game medium group associated with the player in the case where a special condition corresponding to a special game medium is satisfied.

According to a third aspect of the invention, there is provided a game system for running a game on the basis of game media included in a game medium group associated with a player and game media included in a game medium group associated with an opponent, the game system including:

a type processing unit that associates one of a plurality of types with the player;

a game-medium-group processing unit that associates a game medium group including a plurality of special game media with the player; and

a game-medium processing unit that determines a game medium from the game medium group corresponding to the type associated with the player and adds the determined game medium to the game medium group associated with the player in the case where a special condition corresponding to a special game medium is satisfied.

### BRIEF DESCRIPTION OF THE DRAWINGS

FIG. 1 is a schematic block diagram showing the configuration of an information processing system in an embodiment of the present invention.

FIG. 2 is a functional block diagram showing the functions of a server device in the embodiment of the present invention.

FIG. 3 is a functional block diagram showing the functions of a terminal device in the embodiment of the present invention.

FIG. 4 is a figure showing images displayed in a display area of the terminal device in the embodiment of the present invention.

FIG. 5 is a figure for explaining a master list in the embodiment of the present invention.

FIG. 6 is a figure for explaining default decks in the embodiment of the present invention.

FIG. 7 is a figure showing transitions among game modes in the embodiment of the present invention.

FIG. 8 is a figure showing images displayed in the display area of the terminal device in the embodiment of the present invention.

FIG. 9 is a figure for explaining special decks in the embodiment of the present invention.

FIG. 10 is a figure showing images displayed in the display area of the terminal device in the embodiment of the present invention.

FIG. 11 is a figure showing images displayed in the display area of the terminal device in the embodiment of the present invention.

FIG. 12 is a figure showing images displayed in the display area of the terminal device in the embodiment of the present invention.

FIG. 13 is a figure showing images displayed in the display area of the terminal device in the embodiment of the present invention.

FIG. 14 is a figure for explaining lottery tables in the embodiment of the present invention.

FIG. 15 is a flowchart showing a process at the terminal device in the embodiment of the present invention.

FIG. 16 is a flowchart showing a process at the terminal device in the embodiment of the present invention.

FIG. 17 is a flowchart showing a process at the terminal device in the embodiment of the present invention.

FIG. 18 is a flowchart showing a process at the terminal device in the embodiment of the present invention.

### DESCRIPTION OF EXEMPLARY EMBODIMENTS

(1) According to one embodiment of the invention, there is provided a non-transitory computer-readable information storage medium storing a program for running a game on the basis of game media included in a game medium group associated with a player and game media included in a game medium group associated with an opponent, the program causing a computer to function as: a type processing unit that associates one of a plurality of types with the player; a game-medium-group processing unit that associates a game medium group including a plurality of special game media with the player; and a game-medium processing unit that determines a game medium from the game medium group corresponding to the type associated with the player and adds the determined game medium to the game medium group associated with the player in the case where a special condition corresponding to a special game medium is satisfied.

With the present embodiment, in the case where a special condition corresponding to a special game medium is satisfied, it is possible to run the game on the basis of a game medium that is added to the game medium group associated with the player.

(2) Furthermore, in the present embodiment, the game-medium-group processing unit may associate a game medium group including a plurality of kinds of special game media with the player, and the game-medium processing unit may determine a game medium according to a condition corresponding to the kind of special game medium for which the special condition is satisfied.

With this feature, it is possible to add a game medium to the game medium group associated with the player in accordance with the kind of special game medium for which a special condition is satisfied.

(3) Furthermore, in the present embodiment, in the case where the special condition is satisfied, the game-medium processing unit may execute processing for decreasing the number of game media that can be selected by the player from the game medium group associated with the player.

With this feature, in the case where a special condition is satisfied, it is possible to add a game medium to the game medium group associated with the player, while decreasing the number of game media that can be selected by the player from the game medium group associated with the player.

(4) Furthermore, in the present embodiment, the game-medium-group processing unit may associate a game medium group including only special game media with the player.

With this feature, it is possible to simplify the content of the game medium group associated with the player.

(5) Furthermore, in the present embodiment, in the case where the game is started, the game-medium processing unit may determine a prescribed number of game media as game media that can first be selected by the player from the game medium group associated with the player, and the game-medium-group processing unit may associate a game medium group including a plurality of special game media and a number of non-special game media with the player, where the number is greater than or equal to zero and is less than the prescribed number.

With this feature, it is possible to include non-special game media in the game medium group associated with the player, while providing special game media as game media that can first be selected by the player from the game medium group associated with the player.

(6) Furthermore, according to another embodiment of the invention, there is provided a server for running a game on the basis of game media included in a game medium group associated with a player and game media included in a game medium group associated with an opponent, the server including: a type processing unit that associates one of a plurality of types with the player; a game-medium-group processing unit that associates a game medium group including a plurality of special game media with the player; and a game-medium processing unit that determines a game medium from the game medium group corresponding to the type associated with the player and adds the determined game medium to the game medium group associated with the player in the case where a special condition corresponding to a special game medium is satisfied.

(7) Furthermore, according to another embodiment of the invention, there is provided a game system for running a game on the basis of game media included in a game medium group associated with a player and game media included in a game medium group associated with an opponent, the game system including: a type processing unit that associates one of a plurality of types with the player; a game-medium-group processing unit that associates a game medium group including a plurality of special game media with the player; and a game-medium processing unit that determines a game medium from the game medium group corresponding to the type associated with the player and adds the determined game medium to the game medium group associated with the player in the case where a special condition corresponding to a special game medium is satisfied.

Embodiments of the present invention will be described below. Note that the embodiments described below do not unduly limit the content of the present invention recited in the claims. Furthermore, all the components described in the context of the embodiments are not necessarily necessary constituent elements of the present invention.

### 1. Configuration of Information Processing System

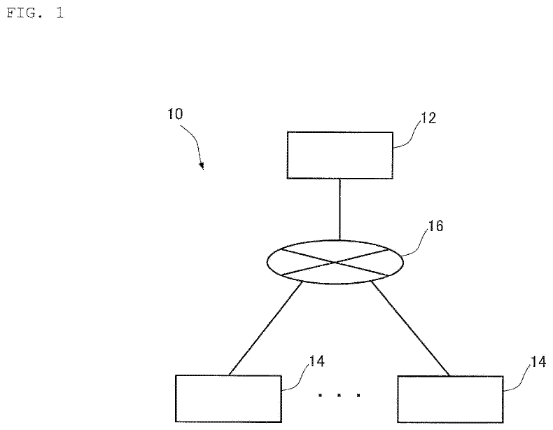

FIG. 1 is a schematic block diagram showing the configuration of an information processing system 10 in this embodiment. As shown in FIG. 1, in the information processing system 10, a server device 12 and a plurality of terminal devices 14 are connected via a network 16, such as the Internet, a mobile phone network, a LAN, or a WAN, which constitutes what is called a client-server communication system. Furthermore, each of the plurality of terminal devices 14 mutually carries out communication with the server device 12 via the network 16 to send and receive various kinds of information, and mutually carries out communication with the other terminal devices 14 via the network 16 and the server device 12 to send and receive various kinds of information.

The server device 12 includes a processor such as a CPU, a main storage device such as a ROM or a RAM, an external storage device such as a hard disk, an input device such as a keyboard, a display device such as a liquid crystal display, a communication device, etc. Furthermore, at the server device 12, the CPU executes various kinds of processing according to programs stored in the main storage device or programs loaded from the external storage device into the main storage device, and receives information from the terminal devices 14 and sends information to the terminal devices 14 by means of the communication device.

Each of the terminal devices 14 may be various types of information processing devices, such as a smartphone, a tablet, a personal computer, a portable game machine, or an installed game machine, which also include a processor such as a CPU, a main storage device such as a ROM or a RAM, an external storage device such as a flash memory or a hard disk, an input device such as a touchscreen, a keyboard, or a microphone, a display device such as a liquid crystal display or an organic EL display, a sound output device such as a speaker, a communication device, etc. Furthermore, also at each of the terminal devices 14, the CPU executes various kinds of processing according to programs stored in the main storage device or programs loaded from the external storage device into the main storage device, and receives information from the server device 12 and sends information to the server device 12 or the other terminal devices 14 by means of the communication device.

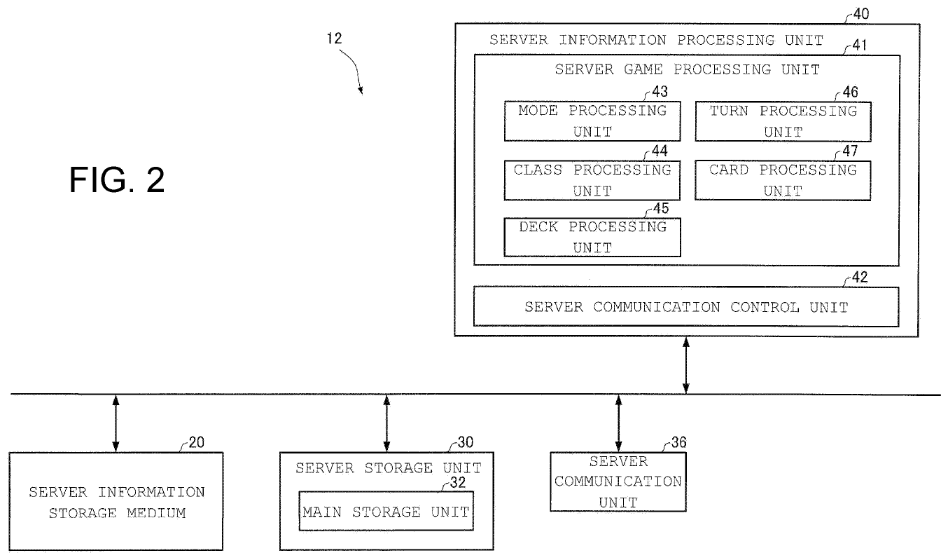

FIG. 2 is a functional block diagram showing the functions of the server device 12 in this embodiment. As shown in FIG. 2, the server device 12 in this embodiment includes a server information storage medium 20, a server storage unit 30, a server communication unit 36, and a server information processing unit 40. Note that these constituent elements (individual units) in FIG. 2 may be partially omitted from the configuration.

The server information storage medium 20 stores programs, data, etc. for the server information processing unit 40 and the server communication unit 36 to execute various kinds of processing, and the function thereof can be realized by a flash memory, a hard disk, an optical disk (DVD or BD), or the like. That is, the server information storage medium 20 stores programs for causing a computer to function as the individual units in this embodiment (programs for causing a computer to execute processing by the individual units).

The server storage unit 30 serves as a work area for the server information processing unit 40 and the server communication unit 36, and the function thereof can be realized by a RAM (main memory), a VRAM (video memory), or the like. Specifically, the server storage unit 30 includes a main storage unit 32 into which programs and data are loaded from the server information storage medium 20.

The server communication unit 36 executes various kinds of control for carrying out communication with an external network (e.g., other server devices 12 and the terminal devices 14), and the function thereof can be realized by hardware such as various kinds of processors (a CPU (main processor), a GPU (rendering processor), a DSP, etc.) or a communication ASIC, programs, or the like.

The server information processing unit 40, by using the main storage unit 32 as a work area, executes various kinds of processing, such as game processing, on the basis of received data received by the server communication unit 36, various kinds of programs and data in the server storage unit 30, etc., and the function thereof can be realized by hardware such as various kinds of processors or an ASIC, or programs.

Furthermore, the server information processing unit 40 includes a server game processing unit 41 and a server communication control unit 42. Note that these components may be partially omitted from the configuration.

The server game processing unit 41 executes processing such as the following on the basis of received data received by the server communication unit 36, the results of various kinds of processing executed by the server information processing unit 40, programs and data loaded into the main storage unit 32, etc.: processing for managing players on the basis of player IDs; processing for starting a game in the case where a game start condition is satisfied; processing for executing a selected game mode among a plurality of kinds of game modes; processing for proceeding with the game; processing for generating an event in the case where an event generation condition is satisfied; processing for computing a game result; and processing for terminating the game in the case where a game termination condition is satisfied.

Specifically, on the basis of player inputs, which are inputs by players at terminal devices 14, the server game processing unit 41 executes various kinds of processing for executing a card game in which a player at one terminal device 14 and a player at another terminal device 14, or a player at one terminal device 14 and a CPU player at the server device 12, select cards to be placed in the field from cards added to their individual hands (game media that can be selected by the players) by a lottery among cards (game media) included in their individual decks (game medium groups) and play a battle by using the cards placed in the field. Furthermore, the server game processing unit 41 includes a mode processing unit 43, a class processing unit 44, a deck processing unit 45, a turn processing unit 46, and a card processing unit 47. Note that these components may be partially omitted from the configuration.

The mode processing unit 43, upon accepting a player input with which a player selects one of a plurality of kinds of game modes, executes processing for setting the game mode selected by the player as the game mode for the player by associating the selected game mode with the player ID of the player.

In this embodiment, it is possible to select a multi-play game mode, in which the individual players at the plurality of terminal devices 14 play battles, or a solo-play game mode, in which the player at one of the terminal devices 14 plays a battle against a CPU player. In the case where the multi-play game mode is selected, processing for matching opponents is executed on the basis of player inputs individually given at the plurality of terminal devices 14.

The class processing unit 44, upon accepting a player input with which a player selects a class from a plurality of kinds of classes (types) including different kinds of cards available in battles, executes processing for setting the class selected by the player as the class for the player by associating the selected class with the player ID of the player. Furthermore, in the case where the opponent is a CPU player, the class processing unit 44 executes processing for setting a class for the CPU player on the basis of a prescribed algorithm. In this embodiment, it is possible to select eight kinds of classes, namely, class A to class H, and the leader character (type) that serves as a leader in a battle varies among the individual classes. Specifically, in this embodiment, there exist eight leader characters, namely, leader character A corresponding to class A to leader character H corresponding to class H, and the leader character corresponding to the class of a player or CPU player is set as the leader character for the player or CPU player.

The deck processing unit 45, upon accepting a player input with which a player selects a deck from a plurality of kinds of decks (types) including different kinds of cards, executes processing for setting the deck selected by the player as the deck for the player by associating the selected deck with the player ID of the player. Furthermore, in the case where the opponent is a CPU player, the deck processing unit 45 executes processing for setting a deck for the CPU player on the basis of a prescribed algorithm.

In this embodiment, as default decks, which can be selected from the time when a player starts the game for the first time, eight kinds of default decks, namely, one kind of default deck A corresponding to class A to one kind of default deck H corresponding to class H, are stored in the server information storage medium 20. Furthermore, as constructed decks, which can be selected on condition that a player clears a mission or otherwise proceeds with the game or on condition that the player makes a payment in an in-game currency or a real currency, a large number of kinds of constructed decks, namely, a plurality of kinds of constructed decks A corresponding to class A to a plurality of kinds of constructed decks H corresponding to class H, are stored in the server information storage medium 20.

Furthermore, in this embodiment, a player is allowed to construct custom decks by combining cards that are possessed from the time when the player starts the game for the first time and cards that have come to be possessed by the player on condition that the player clears a mission or otherwise proceeds with the game or on condition that the player makes a payment in an in-game currency or a real currency, and the player is allowed to select those custom decks. Furthermore, the custom decks are stored in the server information storage medium 20 in association with the player ID.

The turn processing unit 46 executes processing for determining who plays first and who plays second between two players who play a battle or between a player and a CPU player who play a battle. Then, the turn processing unit 46 executes processing for making turns arrive alternately for the first player or CPU player and the second player or CPU player, with the first player or CPU player going first.

Furthermore, in the case of the multi-play game mode, the turn processing unit 46, upon accepting a player input for finishing a turn by a player whose turn has arrived or upon the expiration of 90 seconds, which is the time limit for one turn, finishes the one turn and makes a turn arrive for the other player.

Meanwhile, in the case of the solo-play game mode, in the state where a turn for the player has arrived, irrespective of the time limit for one turn, the turn processing unit 46, upon accepting a player input for finishing a turn by the player, finishes the one turn and makes a turn arrive for the CPU player, and in the state where a turn for the CPU player has arrived, the turn processing unit 46 finishes the one turn and makes a turn arrive for the player on the basis of a prescribed algorithm.

The card processing unit 47 executes processing for determining, by a lottery, a card to be added to the hand of a player whose turn has arrived from the cards remaining after excluding cards already set as the hand of the player from the cards included in the deck of the player and for making a setting so as to add the determined card as the hand of the player.

Furthermore, in the case where the opponent is a CPU player, upon the arrival of a turn for the CPU player, the card processing unit 47 executes processing for determining, by a lottery, a card to be added to the hand of the CPU player from the cards remaining after excluding cards already set as the hand of the CPU player from the cards included in the deck of the CPU player and for making a setting so as to add the determined card as the hand of the CPU player.

Specifically, the card processing unit 47 acquires one random number value from a random number generation unit that randomly generates a random number value for a lottery, and determines one card corresponding to the acquired one random number value with reference to a lottery table including, as items that are subject to the lottery, the cards remaining after excluding cards already set as the hand of the player or CPU player from the cards included in the deck of the player or CPU player.

Here, the random number generation unit can be realized by a random number generator that generates hardware random numbers or a program that generates software random numbers. The software random numbers can be generated, for example, on the basis of the count value of an increment counter (a counter that cyclically counts numerical values within a prescribed count range). Note that, in this embodiment, “random number values” include not only values that are generated randomly in the mathematical sense but also values whose generation itself is systematic but that can substantially function as random values due to irregularity in the acquisition timings or the like thereof.

Specifically, in the case where one battle is started, for each of the two players who play the battle, or in the case where the opponent is a CPU player, for each of one player and the CPU player who play the battle, the card processing unit 47 determines, by a lottery, three (a prescribed number of) cards, which is a predefined number, as candidates for the initial hand of the player or CPU player from the cards included in the deck of the player or CPU player.

Here, in this embodiment, a player is allowed, just once, to select cards to be replaced with other cards among the three cards serving as candidates for the initial hand of the player. Furthermore, upon accepting a player input with which the player selects not to replace any of the three cards serving as candidates for the initial hand of the player with another card, the card processing unit 47 sets the three cards serving as candidates for the initial hand of the player, as they are, as the initial hand of the player.

Meanwhile, upon accepting a player input with which the player selects cards to be replaced with other cards, the card processing unit 47 determines, by another lottery, the same number of cards as the number of cards selected for replacement from the cards remaining after excluding the three cards serving as candidates for the hand of the player from the cards included in the deck of the player. Then, in the case where there exist cards determined by another lottery and cards not selected for replacement, the card processing unit 47 sets the cards serving as the candidates of the initial hand and not selected for replacement as the initial hand of the player.

Furthermore, in the case where the opponent is a CPU player, the card processing unit 47 determines, on the basis of a prescribed algorithm, whether none of the three cards serving as candidates for the initial hand of the CPU player are to be replaced with other cards or one or more of those cards are to be replaced with other cards. Then, when it is determined that none of the cards are to be replaced with other cards, the card processing unit 47 sets the three cards serving as candidates for the initial hand of the CPU player, as they are, as the initial hand of the CPU player.

Meanwhile, when one or more cards to be replaced with other cards are determined, the card processing unit 47 determines, by another lottery, the same number of cards as the number of cards selected for replacement from the cards remaining after excluding the three cards serving as candidates for the hand of the CPU player from the cards included in the deck of the CPU player. Then, in the case where there exist cards determined by another lottery and cards not selected for replacement, the card processing unit 47 selects the cards serving as candidates for the initial hand and not selected for replacement as the initial hand of the CPU player.

Then, in the first turn of the first player or CPU player, the card processing unit 47 determines, by a lottery, one card to be added to the hand of the first player or CPU player from the cards remaining after excluding the cards set as the initial hand of the first player or CPU player.

Meanwhile, in the first turn of the second player or CPU player, the card processing unit 47 determines, by a lottery, two cards to be added to the hand of the second player or CPU player from the cards remaining after excluding cards already set as the hand of the second player or CPU player, i.e., the cards determined as the initial hand of the second player or CPU player, from the cards included in the deck of the second player or CPU player.

Then, in the second and subsequent turns, for both the first player or CPU player and the second player or CPU player, the card processing unit 47 executes processing for determining, by a lottery, one card to be added to the hand.

That is, in this embodiment, since there is a factor that gives the first player or CPU player an advantage, just in the first turn, two cards are added to the hand of the second player or CPU player.

Note that, in this embodiment, the upper limit of the number of cards that can be set as the hand is set to nine. In the case where a turn for a player or CPU player arrives in a state where nine cards are set as the hand of the player or CPU player, processing for determining a card to be added to the hand of the player or CPU player is not executed, so that a new card is not added to the hand of the player or CPU player.

Here, in this embodiment, among the cards that are set as the hand, there exist cards that have set therefor costs as a parameter necessary for placing those cards in the field. Furthermore, in this embodiment, on each turn change, the turn processing unit 46 described earlier assigns play points, which are consumed when a card having a cost set therefor is placed in the field, to the player or CPU player whose turn has arrived.

In this embodiment, first, one point is assigned as the play points for the first turn of the first player or CPU player, then, one point is assigned as the play points for the first turn of the second player or CPU player, then, two points are assigned as the play points for the second turn of the first player or CPU player, and then, two points are assigned as the play points for the second turn of the second player or CPU player. In this manner, the same play points are assigned individually to the first player or CPU player and the second player or CPU player each time their individual turns arrive, and the play points that are assigned are increased by one point each time their individual turns arrive. Note that, in this embodiment, play points that are not consumed in one turn are not carried over to the next turn.

Furthermore, in this embodiment, the maximum value of the play points that are assigned for one turn is set to ten points. Thus, after ten points are assigned as the play points for the individual tenth turns of the first player or CPU player and the second player or CPU player, in their individual eleventh and subsequent turns, ten points are assigned as the play points for their individual eleventh and subsequent turns.

Furthermore, when play points have been assigned to a player or CPU player whose turn has arrived, the card processing unit 47 executes processing for setting, among the cards set as the hand of the player or CPU player whose turn has arrived, cards having costs set therefor less than or equal to the play points assigned in that turn in a play enabled state, in which it is allowed to place those cards in the field, while setting cards having costs set therefor greater than the play points assigned in that turn in a play disabled state, in which it is not allowed to place those cards in the field.

Furthermore, the card processing unit 47 executes processing for setting cards set as the hand of a player or CPU player whose turn has not arrived in the play disabled state, irrespective of the costs set therefor.

Furthermore, the card processing unit 47, upon accepting a player input for placing one of the cards set in the play enabled state in the field among the cards set as the hand of the player whose turn has arrived, executes processing for removing, from the hand of the player, the card for which the player input for placing the card in the field has been accepted and for adding the card as the layout of the player.

Furthermore, in the case where the opponent is a CPU player, the card processing unit 47 executes processing for determining, on the basis of a prescribed algorithm, which of the cards set in the play enabled state is to be placed in the field among the cards set as the hand of the CPU player whose turn has arrived, removing the determined card from the hand of the CPU player, and adding the cards as the layout of the CPU player.

When a new card has been added as the layout of a player or CPU player, the card processing unit 47 executes processing for subtracting the value set as the cost of the newly added card from the value set as the play points of the player or CPU player.

Then, the card processing unit 47 executes processing for setting, among the cards set as the hand of the player or CPU player whose turn has arrived, cards having costs set therefor less than or equal to the play points after the subtraction in the play enabled state, while setting cards having costs set therefor greater than the play points after the subtraction in the play disabled state.

Therefore, in this embodiment, since play points that are assigned in the first turn are one point for both the first player or CPU player and the second player or CPU player, when one card having a cost of one is placed in the field, the play points become zero, so that it becomes no longer possible to further place any card having a cost set therefor in the field. Note, however, that since it is possible to place cards having no costs set therefor, i.e., cards with zero costs, in the field without consuming play points, it is possible to place such cards in the field even when the play points have become zero.

Note that, in this embodiment, the upper limit of the number of cards that can be set as the layout is set to five, so that in the state where five cards are set as the layout of a player or CPU player, a new card is not added as the layout of the player or CPU player.

Here, cards in this embodiment are classified into the following types: follower cards, with which, when set as the layout, it is possible to attack the leader character of the opponent; spell cards, which, when set as the layout, immediately invoke effects and are removed from the layout; and amulet cards, which, when set as the layout, invoke effects when predefined effect invocation conditions are satisfied and are removed from the layout when predefined removal conditions are satisfied.

Furthermore, in this embodiment, with a follower card set as the layout of a player or CPU player, it is possible to attack the leader character of the opponent and also to attack a follower card set as the layout of the opponent, but it is not possible to attack a spell card or an amulet card set as the layout of the opponent.

Furthermore, each follower card has set therefor attacking ability, physical energy, and cost as card parameters. Furthermore, each spell card or amulet card has a cost set therefor as a card parameter, while not having attacking ability or physical energy set therefor. Note that there exist cards having zero cost set therefor, i.e., having no cost set therefor, among follower cards, spell cards, and amulet cards.

Furthermore, for follower cards set as the layout of a player or CPU player whose turn has not arrived, the card processing unit 47 executes processing for setting those cards in an attack disabled state, in which it is not possible to attack therewith the leader character or a follower card of the opponent.

Furthermore, among the follower cards set as the layout of a player or CPU player whose turn has arrived, for follower cards added as the layout in the last and previous turns of the player or CPU player, the card processing unit 47 executes processing for setting those cards in an attack enabled state, in which it is possible to attack therewith the leader character or a follower card of the opponent, and for follower cards newly added as the layout in the current turn of the player or CPU player, the card processing unit 47 executes processing for setting those cards in the attack disabled state.

That is, in this embodiment, with a follower card added as the layout in the current turn, basically, it is not possible to attack the leader character or a follower card of the opponent in the current turn.

Furthermore, the card processing unit 47, upon accepting a player input for evolving one of the follower cards set as the layout of a player whose turn has arrived, executes evolution processing for evolving the follower card for which the player input for evolution has been accepted. Then, with the follower card subjected to the evolution processing, the attacking ability and physical energy are increased, or the card graphics change.

Furthermore, in the case where the opponent is a CPU player, the card processing unit 47 executes processing for determining, on the basis of a prescribed algorithm, which follower card is to be evolved among the cards set as the layout of the CPU player whose turn has arrived, and for evolving the determined follower card by increasing the attacking ability and physical energy of the follower card.

Here, in this embodiment, since there is a factor that gives the first player or CPU player an advantage, as described above, the permissible number of evolutions is set to two for the first player or CPU player, and the permissible number of evolutions is set to three for the second player or CPU player, where the number of permissible evolutions refers to the number of times follower cards can be evolved.

Furthermore, in this embodiment, as described earlier, for follower cards newly added as the layout in the current turn of a player or CPU player, the card processing unit 47 first sets those cards in the attack disabled state; however, in the case where processing for evolving one of those cards is executed in the current turn, the card processing unit 47 sets the follower card for which the evolution processing has been executed in the attack enabled state.

Furthermore, the card processing unit 47 executes processing for selecting, as the subject of an attack, a follower card set in the attack enabled state among the follower cards set as the layout of the player whose turn has arrived. Then, upon accepting a player input for selecting one of the follower cards of the opponent as the target of the attack, the card processing unit 47 executes processing for setting the follower card of the player, selected as the subject of the attack, as the subject of the attack and for setting the follower card of the opponent, selected as the target of the attack, as the target of the attack.

Furthermore, in the case where the opponent is a CPU player, the card processing unit 47 executes processing for setting, on the basis of a prescribed algorithm, a follower card set in the attack enabled state as the subject of the attack among the follower cards set as the layout of the CPU player whose turn has arrived, and for setting one of the follower cards of the opponent as the target of the attack.

Then, the card processing unit 47 executes processing for subtracting the value set as the attacking ability of the follower card of the player or CPU player, serving as the subject of the attack, from the value set as the physical energy of the follower card of the opponent, serving as the target of the attack, and also executes processing for subtracting the value set as the attacking ability of the follower card of the opponent, serving as the target of the attack, from the value set as the physical energy of the follower card of the player, serving as the subject of the attack.

Then, the card processing unit 47 executes processing for removing any follower card whose physical energy has become less than or equal to zero from the layout of the player or CPU player and for setting the follower card as a card in the graveyard of the player or CPU player.

Furthermore, the card processing unit 47 executes processing for selecting, as the subject of an attack, a follower card set in the attack enabled state among the follower cards set as the layout of the player whose turn has arrived. Then, upon accepting a player input for selecting the leader character of the opponent as the target of the attack, the card processing unit 47 executes processing for setting the follower card of the player, selected as the subject of the attack, as the subject of the attack and for setting the leader character the opponent, selected as the target of the attack, as the target of the attack.

Furthermore, in the case where the opponent is a CPU player, the card processing unit 47 executes processing for setting, on the basis of a prescribed algorithm, a follower card set in the attack enabled state as the subject of an attack among the follower cards set as the layout of the CPU player whose turn has arrived, and for setting the leader character of the opponent as the target of the attack.

Then, the card processing unit 47 executes processing for subtracting the value set as the attacking ability of the follower card of the player or CPU player, serving as the subject of the attack, from the value set as the physical energy of the leader character of the opponent, serving as the target of the attack, while not executing processing for subtracting the physical energy of the follower card of the player, serving as the subject of the attack, since the leader character has no attacking ability set therefor. Alternatively, the attacking ability of the leader character may be set to zero.

That is, in this embodiment, when follower cards are set as the subject of an attack and the target of the attack, subtraction is performed from the physical energy of both the follower card serving as the subject of the attack and the follower card serving as the target of the attack, whereas when a follower card is set as the subject of an attack and a leader character is set as the target of the attack, subtraction is unilaterally performed from the physical energy of the leader character, and the leader character is not allowed to serve as the subject of an attack.

Furthermore, in the case where the physical energy of the leader character of a player or CPU player has become less than or equal to zero, the card processing unit 47 determines that the player or CPU player has been defeated, while determining that the other player or CPU player has won. Furthermore, in the case where there exists no card that has not yet been set as the hand in the deck of a player or CPU player whose turn has arrived, i.e., in the case where there is no more card that can be added to the hand, the card processing unit 47 determines that the player or CPU player has been defeated, while determining that the other player or CPU player has won.

Furthermore, the card processing unit 47 sets the follower card of the player or CPU player, set as the target of the attack, in the attack disabled state until the next turn for the player or CPU player arrives. That is, in this embodiment, with a follower card used to attack the leader character or a follower card of the opponent in the current turn, it is not allowed to attack the leader character or the follower card of the opponent again.

The server communication control unit 42 executes processing for causing the server communication unit 36 to carry out communication with other server devices 12 or the terminal devices 14 to send and receive various kinds of information. For example, the server communication control unit 42 causes the server communication unit 36 to send and receive information needed in processing for newly registering a player in the information processing system 10, information needed in processing for allowing a player to log into the information processing system 10, information needed in processing for setting a player or CPU player who cooperates with or plays a battle against a player who has logged in, information needed in processing for synchronizing the plurality of terminal devices 14, information needed in processing for executing a common game at the plurality of terminal devices 14, etc. Furthermore, the server communication control unit 42 also causes the server communication unit 36 to send and receive destination information indicating a destination of information, source information indicating a source of information, identification information identifying the information processing system 10 that has generated information, etc.

In particular, the server communication control unit 42 executes processing for receiving various kinds of player inputs acquired at the individual terminal devices 14 from the individual terminal devices 14 and for sending information concerning opponents and the results of various kinds of processing at the server game processing unit 41 to the individual terminal devices 14.

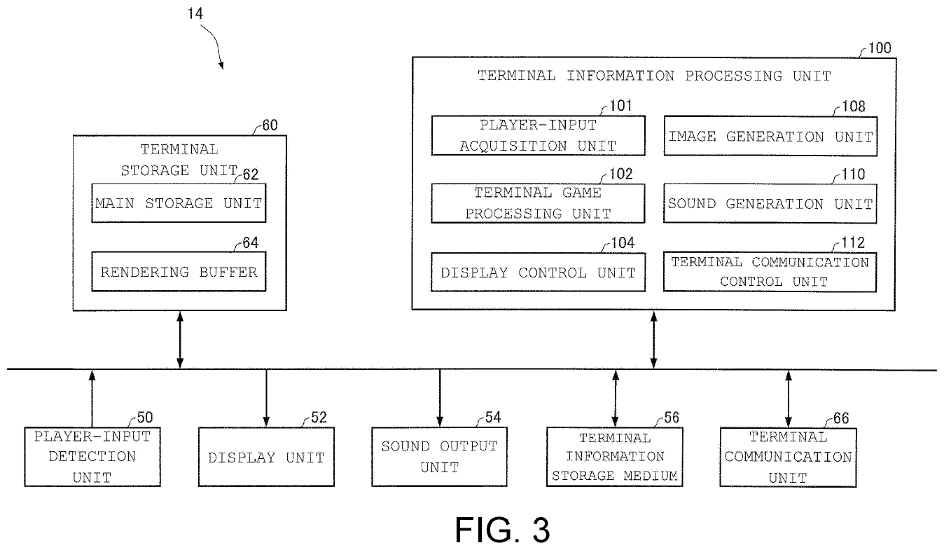

FIG. 3 is a functional block diagram showing the functions of each of the terminal devices 14 in this embodiment. As shown in FIG. 3, each of the terminal devices 14 in this embodiment includes a player-input detection unit 50, a display unit 52, a sound output unit 54, a terminal information storage medium 56, a terminal storage unit 60, a terminal communication unit 66, and a terminal information processing unit 100. Note that the constituent elements (individual units) in FIG. 3 may be partially omitted from the configuration.

The player-input detection unit 50 detects inputs to the terminal device 14 by a player as player inputs, and the function thereof can be realized by a touch sensor, a switch, an optical sensor, a microphone, or the like.

The display unit 52 displays images on a display screen, and the function thereof can be realized by a liquid crystal display, an organic EL display, or the like.

The sound output unit 54 outputs sound, and the function thereof can be realized by a speaker, headphones, or the like.

The terminal information storage medium 56 stores programs, data, etc. for the terminal information processing unit 100 and the terminal communication unit 66 to execute various kinds of processing, and the function thereof can be realized by a flash memory, a hard disk an optical disk (DVD or BD), or the like. That is, the terminal information storage medium 56 stores programs for causing a computer to function as the individual units in this embodiment (programs for causing a computer to execute processing by the individual units).

The terminal storage unit 60 serves as a work area for the terminal information processing unit 100 and the terminal communication unit 66, and the function thereof can be realized by a RAM (main memory), a VRAM (video memory), etc. Specifically, the terminal storage unit 60 includes a main storage unit 62 into which programs and data are loaded from the terminal information storage medium 56 and a rendering buffer 64 in which an image to be displayed on the display unit 52 is rendered.

The terminal communication unit 66 executes various kinds of control for carrying out communication with an external network (e.g., the server device 12 or the other terminal devices 14), and the function thereof can be realized by hardware such as various kinds of processors or a communication ASIC, programs, or the like.

Note that the programs (data) for causing a computer to function as the individual units in this embodiment may be downloaded from the server device 12 to the terminal information storage medium 56 (or the main storage unit 62) of the terminal device 14 via the network 16 and the terminal communication unit 66, and such usage of the server device 12 can also be encompassed in the scope of the present invention.

The terminal information processing unit 100, by using the main storage unit 62 as a work area, executes various kinds of processing, such as game processing, image generation processing, and sound generation processing, on the basis of player inputs detected by the player-input detection unit 50, received data received by the terminal communication unit 66, various kinds of program and data in the terminal storage unit 60, etc., and the function thereof can be realized by hardware such as various kinds of processors (a CPU (main processor), a GPU (rendering processor), a DSP, etc.) or an ASIC, or programs.

Furthermore, the terminal information processing unit 100 includes a player-input acquisition unit 101, a terminal game processing unit 102, a display control unit 104, an image generation unit 108, a sound generation unit 110, and a terminal communication control unit 112. Note that these units may be partially omitted from the configuration.

The player-input acquisition unit 101 acquires player inputs, as kinds of inputs corresponding to situations, on the basis of player inputs detected by the player-input detection unit 50, programs and data loaded into the main storage unit 62, etc. For example, when a GUI, such as a button, is tapped in a state where the GUI is displayed, the player input is acquired as an input corresponding to the kind of GUI displayed. Specifically, the player-input acquisition unit 101 acquires various kinds of player inputs, such as player inputs for selecting a game mode, a class, and a deck, player inputs for matching opponents, player inputs for finishing turns, player inputs for placing cards in the field, and player inputs for attacking follower cards or leader characters of opponents.

The terminal game processing unit 102 executes processing for starting a game in the case where a game start condition is satisfied, processing for executing a selected game mode among a plurality of kinds of game modes, processing for proceeding with the game, processing for generating an event in the case where an event generation condition is satisfied, processing for computing a game result, processing for terminating the game in the case where a game termination condition is satisfied, etc. on the basis of player inputs acquired by the player-input acquisition unit 101, received data received by the terminal communication unit 66, the results of various kinds of processing executed by the terminal information processing unit 100, programs and data loaded into the main storage unit 62, etc.

The display control unit 104 controls the displaying of images that are displayed on the display unit 52. Specifically, the display control unit 104 executes display control concerning the displayed content, display modes, display timings, etc. of various objects and prerendering images (movie images) on the basis of player inputs acquired by the player-input acquisition unit 101, received data received by the terminal communication unit 66, the results of various kinds of processing executed by the terminal information processing unit 100, programs and data loaded into the main storage unit 62, etc.

In this embodiment, the terminal information storage medium 56 stores object data of various objects, such as card objects for displaying cards, character objects for displaying characters, non-character objects for displaying items other than characters, such as buildings, tools, vehicles, and terrains, background objects for displaying backgrounds, effect objects for displaying effects, and GUI (Graphic User Interface) objects for displaying GUIs such as buttons, as well as image data of various prerendering images. Furthermore, the display control unit 104 executes display control for objects and prerendering images in accordance with the kind of game mode being executed and the status of progress of the game, on the basis of object data and image data of prerendering images loaded into the main storage unit 62.

Specifically, for objects constituted of primitives representing the objects, such as polygons, free surfaces, or two-dimensional images, on the basis of object data loaded into the main storage unit 62, the display control unit 104 executes processing for disposing those objects in an object space, moving the objects, or causing those objects to take actions. Specifically, on the basis of player inputs acquired by the player-input acquisition unit 101, received data received by the terminal communication unit 66, the results of various kinds of processing executed by the terminal information processing unit 100, programs and data loaded into the main storage unit 62, etc., the display control unit 104, in every frame (e.g., 1/30 seconds), determines the positions and orientations (rotation angles) of objects in the object space, and disposes the objects at the determined positions in the determined orientations or causes a plurality of parts constituting the objects to individually take actions.

The image generation unit 108 executes processing for rendering a game image on the rendering buffer 64 on a per-frame basis on the basis of player inputs acquired by the player-input acquisition unit 101, received data received by the terminal communication unit 66, the results of various kinds of processing executed by the terminal information processing unit 100, in particular, the results of various kinds of processing executed by the display control unit 104, programs and data loaded into the main storage unit 62, etc., thereby generating a game image in which various objects and various prerendering images are displayed. Then, the image generation unit 108 outputs the generated game image to the display unit 52, on which the game image is displayed.

Note that the functions of the display control unit 104 and the image generation unit 108 of the terminal device 14 may be provided in the server device 12.

The sound generation unit 110 executes sound processing on the basis of the results of various kinds of processing executed by the terminal information processing unit 100, thereby generating game sound such as BGM, sound effects, or voice, and outputs the game sound to the sound output unit 54.

The terminal communication control unit 112 executes processing for causing the terminal communication unit 66 to carry out communication with the server device 12 or the other terminal devices 14 to send and receive various kinds of information. For example, the terminal communication control unit 112 causes the terminal communication unit 66 to send and receive information needed in processing for newly registering a player in the information processing system 10, information needed in processing for allowing a player to log into the information processing system 10, information needed in processing for setting another player who cooperates with or plays a battle against a player who has logged in, information needed in processing for synchronizing the plurality of terminal devices 14, information needed in processing for executing a common game at the plurality of terminal devices 14, etc. Furthermore, the terminal communication control unit 112 also causes the terminal communication unit 66 to send and receive destination information indicating a destination of information, source information indicating a source of information, identification information identifying the information processing system 10 that has generated information, etc.

In particular, the terminal communication control unit 112 executes processing for receiving, from the server device 12, information concerning the opponent and the results of various kinds of processing by the server game processing unit 41, and for sending, to the server device 12, information concerning the player at the terminal device 14 and player inputs acquired by the player-input acquisition unit 101.

### 2. Control Method in the Embodiment

The following describes a control method in the embodiment in detail in the context of an example in the case where a game program in this embodiment is applied to a game app for a smartphone (the terminal device 14).

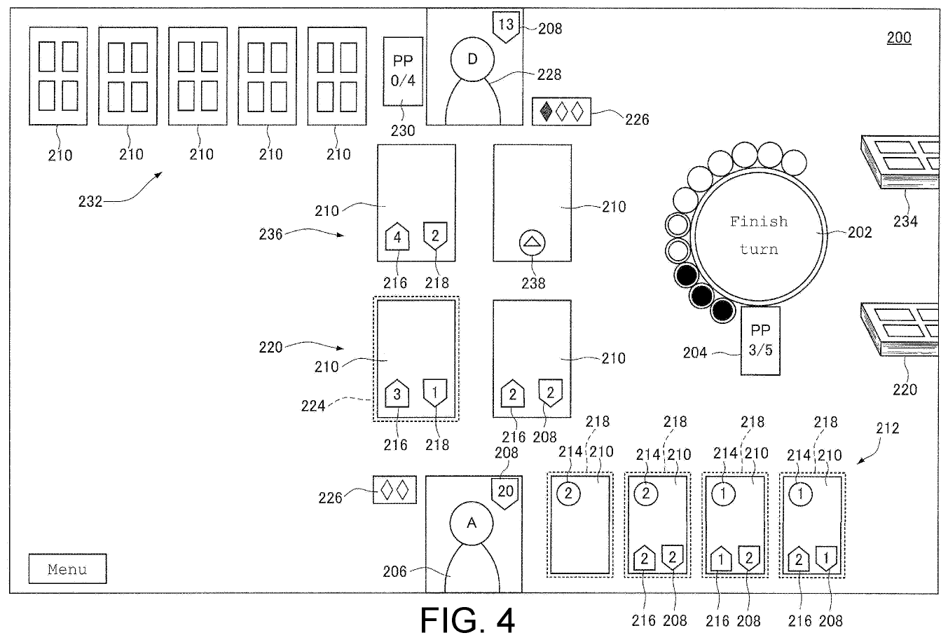

FIG. 4 shows an example of game images in a card game, displayed in a display area 200 of a touchscreen display of the smartphone by the game program in this embodiment. In this embodiment, as shown in FIG. 4, in a middle right part of the display area 200, a turn finish button 202 for finishing a turn for the player at the local terminal is displayed. When the turn finish button 202 is tapped, the turn for the player at the local terminal is finished, and a turn for the opponent is started.

Furthermore, under the turn finish button 202, a local-terminal PP indication 204 indicating the play points (PP) of the player at the local terminal is displayed. The local-terminal PP indication 204 indicates the play points at the start of a turn and the currently remaining play points of the player at the local terminal. In the example in FIG. 4, the player at the local terminal is playing a turn, and the local-terminal PP indication 204 indicates that the play points at the start of the turn are five points and that the currently remaining play points are three points.

Furthermore, in a center lower part of the display area 200, a local-terminal leader image 206 indicating the leader character of the player at the local terminal is displayed, and in an upper right part of the local-terminal leader image 206, a physical energy indication 208 indicating the physical energy of the leader character of the player at the local terminal is displayed. In the example in FIG. 4, since class A is set as the class of the player at the local terminal, leader character A corresponding to class A is displayed as the local-terminal leader image 206.

Furthermore, on the right side of the local-terminal leader image 206, a local-terminal hand area 212 is provided, in which card images 210 corresponding to the cards set as the hand of the player at the local terminal are displayed. In the local-terminal hand area 212, it is possible to display a maximum of nine card images 210. In the example in FIG. 4, four card images 210 are displayed in the local-terminal hand area 212.

Furthermore, for each of the card images 210 displayed in the local-terminal hand area 212, although not shown, a cost indication 214 indicating the cost of the card, an attacking ability indication 216 indicating the attacking ability of the card, or a physical energy indication 208 indicating the physical energy of the card, as well as the name and graphics of the card, are displayed. In the example in FIG. 4, of the four card images 210 displayed in the local-terminal hand area 212, the first card image 210 from the left is a card image 210 for a spell card, and a cost indication 214 is displayed, but an attacking ability indication 216 and a physical energy indication 208 are not displayed. Furthermore, the second to fourth card images 210 from the left are card images 210 for follower cards, and cost indications 214, attacking ability indications 216, and physical energy indications 208 are displayed.

Furthermore, in the example in FIG. 4, the currently remaining play points of the player at the local terminal are three points, and the individual cost indications 214 of the four cards displayed in the local-terminal hand area 212 indicate points less than or equal to three points, and thus a play enabled indication 218 indicating that the card is in the play enabled state is displayed in each of the four card images 210 displayed in the local-terminal hand area 212.

Furthermore, on the upper left side of the local-terminal hand area 212, a local-terminal deck image 220 indicating the deck of the player at the local terminal is displayed. In the case where a card is added to the hand of the player at the local terminal, a card image 210 is displayed so as to move from the local-terminal deck image 220 to the local-terminal hand area 212.

Furthermore, on the upper left side of the local-terminal hand area 212, a local-terminal layout area 222 is provided, in which card images 210 corresponding to the cards set as the layout of the player at the local terminal are displayed. In the local-terminal layout area 222, it is possible to display a maximum of five card images 210. In the example in FIG. 4, two card images 210 are displayed in the local-terminal layout area 222.

Furthermore, in the card images 210 displayed in the local-terminal layout area 222, although not shown, in the case of a follower card, an attacking ability indication 216 and a physical energy indication 208, as well as the name and graphics of the card, are displayed, but a cost indication 214 is not displayed since the cost has already been consumed as a result of being placed in the field from the hand. In the example in FIG. 4, each of the two card images 210 displayed in the local-terminal layout area 222 is a card image 210 for a follower card, and thus an attacking ability indication 216 and a physical energy indication 208 are displayed.

Furthermore, in the example in FIG. 4, of the two card images 210 displayed in the local-terminal layout area 222, the left card image 210 is a card image 210 corresponding to a follower card added as the layout in the last turn for the player at the local terminal, and thus an attack enabled indication 224 indicating that the card is in the attack enabled state is displayed. Meanwhile, the right card image 210 is a card image 210 corresponding to a follower card added as the layout in the current turn for the player at the local terminal, and thus the attack enabled indication 224 is not displayed.

Furthermore, on the left side of the local-terminal leader image 206, a permissible evolution number indication 226 indicating the permissible number of evolutions for the player at the local terminal is displayed. In the example in FIG. 4, since the player at the local terminal is the first player, the permissible evolution number indication 226 indicates that the initial value of the permissible number of evolutions for the player at the local terminal is two and that the currently remaining permissible number of evolutions is two.

Furthermore, in an upper center part of the display area 200, an opponent leader image 228 indicating the leader character of the opponent is displayed, and in an upper right part of the opponent leader image 228, a physical energy indication 208 indicating the physical energy of the leader character of the opponent is displayed. In the example in FIG. 4, since class D is set as the class of the opponent, leader character D corresponding to class D is displayed as the opponent leader image 228.

Furthermore, on the left side of the opponent leader image 228, an opponent PP indication 230 indicating the play points of the opponent is displayed, and the opponent PP indication 230 indicates the play points at the start of a turn for the opponent and the currently remaining play points. In the example in FIG. 4, the player at the local terminal is playing a turn, and it is indicated that the play points at the start of the turn for the opponent immediately preceding the turn for the player at the local terminal are four points and that the currently remaining play points are zero points.

Furthermore, on the left side of the opponent PP indication 230, an opponent hand area 232 is provided, in which card images 210 corresponding to the cards set as the hand of the opponent are displayed. In the opponent hand area 232, it is possible to display a maximum of nine card images 210. In the example in FIG. 4, five card images 210 are displayed in the opponent hand area 232.

Furthermore, in each of the card images 210 displayed in the opponent hand area 232, the graphics of the bottom face of the card are displayed, and the name, graphics, cost indication 214, attacking ability indication 216, or physical energy indication 208 of the card are not displayed. That is, the player at the local terminal is allowed to recognize the number of cards set as the hand of the opponent on the basis of the card images 210 displayed in the opponent hand area 232, but is not allowed to recognize the content of the card set as the hand of the opponent.

Furthermore, on the upper side of the local-terminal deck image 220 displayed at the right end of the display area 200, described above, an opponent deck image 234 indicating the deck of the opponent is displayed. In the case where a card is added to the hand of the opponent, a card image 210 is displayed so as to move from the opponent deck image 234 to the opponent hand area 232.

Furthermore, on the lower side of the opponent leader image 228, i.e., on the upper side of the local-terminal layout area 222, an opponent layout area 236 is provided, in which card images 210 corresponding to the cards set as the layout of the opponent are displayed. It is possible to display a maximum of five card images 210 in the opponent layout area 236. In the example in FIG. 4, two card images 210 are displayed in the opponent layout area 236.

Furthermore, in each of the card images 210 displayed in the opponent layout area 236, although not shown, in the case of a follower card, an attacking ability indication 216 and a physical energy indication 208, as well as the name and graphics of the card, are displayed, but a cost indication 214 is not displayed since the cost has already been consumed as a result of the card being placed in the field from the hand. In the example in FIG. 4, of the two card images 210 displayed in the opponent layout area 236, the left card image 210 is a card image 210 for a follower card, and thus an attacking ability indication 216 and a physical energy indication 208 are displayed. Meanwhile, the right card image 210 is a card image 210 for an amulet card. Since an amulet card has no attacking ability or physical energy set therefor, in the card image 210 corresponding to an amulet card, an attacking ability indication 216 or a physical energy indication 208 is not displayed, but an effect indication 238 indicating the effect set for the amulet card is displayed.

Furthermore, on the right side of the opponent leader image 228, a permissible evolution number indication 226 indicating the permissible number of evolutions for the opponent is displayed. In the example in FIG. 4, since the opponent is the second player, the permissible evolution number indication 226 indicates that the initial value of the permissible number of evolutions for the opponent is three and that the currently remaining permissible number of evolutions is two.

Furthermore, in this embodiment, in a turn for the player at the local terminal, with the card images 210 for which play enabled indications 218 are displayed in the local-terminal hand area 212, when the player at the local terminal drags and drops one of those card images 210 in the local-terminal layout area 222 while touching that card image 210, this operation is acquired as a player input for placing the card corresponding to the dropped card image 210 in the field. Then, the dropped card image 210 is displayed in the local-terminal layout area 222 with the cost indication 214 erased, and the result of subtracting the cost of the card corresponding to the dropped card image 210 from the currently remaining play points in the local-terminal PP indication 204 is displayed.

Furthermore, in a turn for the player at the local terminal, when the player at the local terminal performs a drag from one of the card images 210 for follower cards, for which attack enabled indications 224 are displayed in the local-terminal layout area 222, to one of the card images 210 for follower cards, displayed in the opponent layout area 236, this operation is acquired as a player input for selecting the card image 210 for the follower card at the start point of the drag as the subject of an attack and for selecting the card image 210 for the follower card at the end point of the drag as the target of the attack. Then, in the card image 210 for the follower card of the player at the local terminal, serving as the subject of the attack, and the card image 210 for the follower card of the opponent, serving as the target of the attack, effect images indicating attacks on each other are displayed, and the results of performing subtraction from the physical energy indication 208 of the card image 210 for the follower card of the player at the local terminal, serving as the subject of the attack, and the physical energy indication 208 of the card image 210 for the follower card of the opponent, serving as the target of the attack, are displayed. Furthermore, the card images 210 for follower cards whose physical energy indications 208 have come to indicate values less than or equal to zero are deleted from the local-terminal layout area 222 or the opponent layout area 236.

Furthermore, in a turn for the player at the local terminal, when the player at the local terminal performs a drag from one of the card images 210 for follower cards, for which attack enabled indications 224 are displayed in the local-terminal layout area 222, to the opponent leader image 228, this operation is acquired as a player input for selecting the card image 210 for the follower card at the start point of the drag as the subject of an attack and for selecting the opponent leader image 228 at the end point of the drag as the target of the attack. Then, an effect image indicating being attacked is displayed in the opponent leader image 228 serving as the target of the attack, and the result of performing subtraction from the physical energy indication 208 of the opponent leader image 228 serving as the target of the attack is displayed. Furthermore, when the physical energy indication 208 of the opponent leader image 228 comes to indicate a value less than or equal to zero, an indication indicating a victory for the player at the local terminal is displayed.

Furthermore, in this embodiment, in a turn for the opponent, each time one card is added as the layout of the opponent, one card image 210 is displayed so as to move from the opponent hand area 232 to the opponent layout area 236. Then, the card image 210 corresponding to the card added as the layout of the opponent is displayed in the opponent layout area 236 with the cost indication 214 erased, and the result of subtracting the cost of the card displayed in the opponent layout area 236 from the currently remaining play points in the opponent PP indication 230 is displayed.

Furthermore, in a turn for the opponent, of the card images 210 displayed in the opponent layout area 236, attack enabled indications 224 are displayed in the card images 210 corresponding to follower cards set in the attack enabled state.

Furthermore, in a turn for the opponent, when one of the follower cards set in the attack enabled state among the follower cards set as the hand of the opponent is set as the subject of an attack and one of the follower cards of the player at the local terminal is set as the target of the attack, in the card image 210 for the follower card of the opponent, serving as the subject of the attack, and the card image 210 for the follower card of the player at the local terminal, serving as the target of the attack, effect images indicating attacks on each other are displayed, the results of performing subtraction from the physical energy indication 208 of the card image 210 for the follower card of the opponent, serving as the subject of the attack, and the physical energy indication 208 of the card image 210 for the follower card of the player at the local terminal, serving as the target of the attack, are displayed. Furthermore, the card images 210 for follower cards whose physical energy indications 208 have come to indicate values less than or equal to zero are deleted from the local-terminal layout area 222 or the opponent layout area 236.

Furthermore, in a turn for the opponent, when one of the follower cards set in the attack enabled state among the follower cards set as the layout of the opponent is set as the subject of an attack and the local-terminal leader character is set as the target of the attack, an effect image indicating being attacked is displayed in the local-terminal leader image 206 serving as the target of the attack, and the result of performing subtraction from the physical energy indication 208 of the local-terminal leader image 206 serving as the target of the attack is displayed. Furthermore, when the physical energy indication 208 of the local-terminal leader image 206 comes to indicate a value less than or equal to zero, an indication indicating a defeat for the player at the local terminal is displayed.

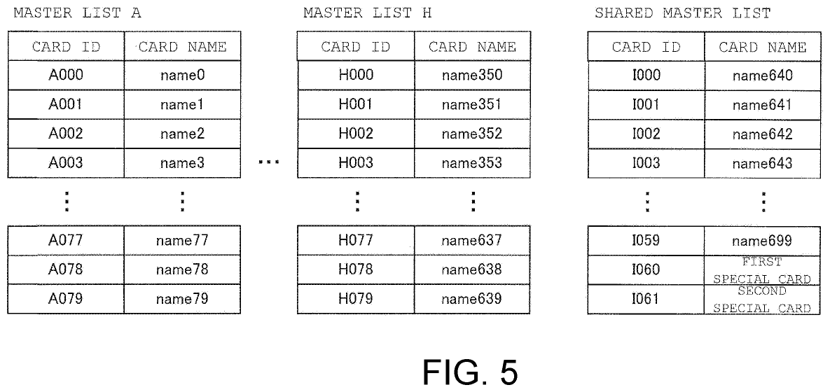

FIG. 5 shows master lists serving as lists of all the cards in the card game in this embodiment. The master lists in this embodiment are stored in the server information storage medium 20. As shown in FIG. 5, the master lists include eight kinds of per-class master lists, namely, master list A corresponding to class A to master list H corresponding to class H, as well as one kind of shared master list corresponding to all the eight kinds of classes from class A to class H.

Each of the eight kinds of per-class master lists is an exhaustive list of cards that can be included in a deck in the case where the class of a player or CPU player is the corresponding class; for example, master list A is an exhaustive list of cards for class A, which can be included in the deck in the case where the class of the player or CPU player is class A, . . . , and master list H is an exhaustive list of cards for class H, which can be included in the deck in the case where the class of the player or CPU player is class H.

Specifically, in each of the eight kinds of per-class master lists, various kinds of card information are associated with each of the card IDs of 80 kinds of cards for each of the classes; for example, in master list A, various kinds of card information, such as a card name, a card classification, a cost, an attacking ability, a physical energy, an effect, an effect generation condition, a removal condition, and a rarity, are associated with each of the card IDs of the 80 kinds of cards for class A with card IDs from A000 to A079, . . . , and in master list H, various kinds of card information are associated with each of the card IDs of the 80 kinds of cards for class H with card IDs from H000 to H079.

Furthermore, the shared master list is an exhaustive list of cards shared among the individual classes, which can be included in a deck irrespective of the class of a player or CPU player. Specifically, in the shared master list, various kinds of card information are associated with each of the card IDs of the 62 kinds of cards with card IDs from I000 to I061, shared among the individual classes.

Note that, in this embodiment, each of the eight kinds of per-class master list and the one kind of shared master list includes follower cards, spell cards, and amulet cards.

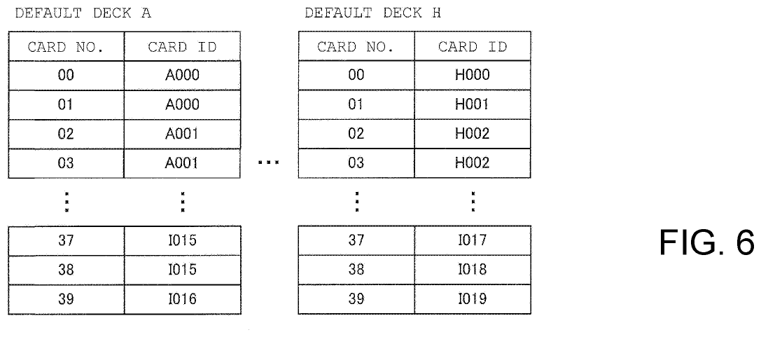

FIG. 6 shows eight kinds of default decks, namely, default deck A corresponding to class A to default deck H corresponding to class H, described above, stored in the server information storage medium 20.

As shown in FIG. 6, default deck A includes 40 cards in total, including a plurality of cards for class A and a plurality of card shared among classes, such as two cards with the card ID A000, two cards with the card ID A001, . . . , two cards with the card ID 1015, and one card with the card ID 1016. Furthermore, default deck H includes 40 cards in total, including a plurality of cards for class H and a plurality of cards shared among classes, such as one card with the card ID H000, one card with the card ID H001, two cards with the card ID H002, . . . , one card with the card ID 1017, one card with the card ID 1018, and one card with the card ID 1019. That is, each of the eight kinds of default decks includes 40 cards in total, including a plurality of cards specific to a class and a plurality of cards shared among classes.

Furthermore, in this embodiment, although not shown, the server information storage medium 20 stores a large number of kinds of constructed decks, from a plurality of kinds of constructed decks A corresponding to class A to a plurality of kinds of constructed decks H corresponding to class H, described above.

Furthermore, each of the large number of kinds of constructed decks is a constructed deck that can be set in the case where the class of a player or CPU player is the corresponding class; for example, each of the plurality of kinds of constructed decks A is a constructed deck that can be set in the case where the class of the player or CPU player is class A, . . . , and each of the plurality of kinds of constructed decks H is a default deck that can be set in the case where the class of the player or CPU player is class H.

Specifically, similarly to each of the eight kinds of default decks, each of the large number of kinds of constructed decks includes 40 cards in total, including a plurality of cards specific to a class and a plurality of classes shared among classes; for example, each of the plurality of kinds of constructed decks A includes 40 cards in total, including a plurality of cards for class A and a plurality of cards shared among classes, . . . , and each of the plurality of kinds of constructed decks H includes 40 cards in total, including a plurality of cards for class H and a plurality of cards shared among classes.

Here, each of the eight kinds of default decks in this embodiment is constructed such that the default deck includes few cards with high attacking ability or physical energy, few cards with advantageous effects, effect generation conditions, and removal conditions, or few cards with high rarity. That is, each of the eight kinds of default decks is a deck that can be selected from the time when a player starts the game for the first time, and is thus constructed such that the degree of giving the player an advantage is low.

Meanwhile, each of the large number of kinds of constructed decks is constructed such that, depending on the kind of constructed deck, the constructed deck includes many cards with high attacking ability or physical energy, many cards with advantageous effects, effect generation conditions, and removal conditions, or many cards with high rarity. That is, the large number of kinds of constructed decks individually have different conditions for allowing selection by a player, and thus are constructed to have different degrees of giving the player an advantage in accordance with the conditions for allowing selection by the player.

Furthermore, although not shown, the server information storage medium 20 can also store the custom decks described earlier, and each of the custom decks is also constructed as a custom deck corresponding to one of the eight kinds of classes from class A to class H. Specifically, in this embodiment, in the case where a player constructs a custom deck, first, a player input is accepted, with which the player selects one of the eight kinds of classes from class A to class H. Then, of the cards possessed by the player, the player combines cards for the class corresponding to the class selected by the player and cards shared among classes such that the total number becomes 40, thereby constructing a custom deck. Note that in the case where the player possesses multiple cards of the same kind, similarly to a default deck and a constructed deck, it is possible to include multiple cards of the same kind in a custom deck.

As described above, in this embodiment, default decks, constructed decks, and custom decks each correspond to one of the eight kinds of classes from class A to class H, and each include 40 cards in total, including cards specific to a class and cards shared among classes.

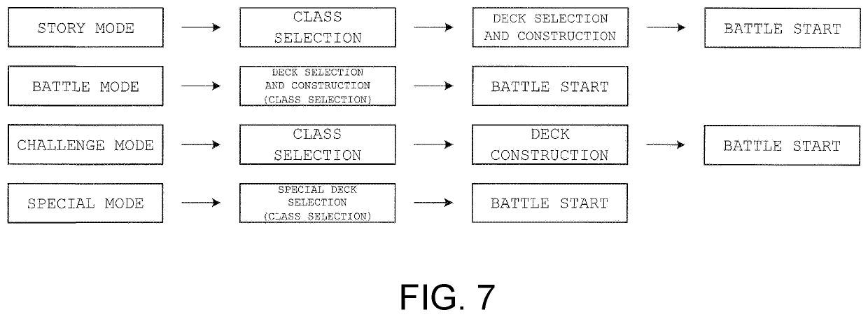

FIG. 7 shows phase transitions before the start of a battle in each of a plurality of kinds of game modes. As shown in FIG. 7, in this embodiment, a player can select one of four kinds of game modes, namely, a story mode, a battle mode, a challenge mode, and a special mode. The story mode is a solo-play game mode, and each of the battle mode, the challenge mode, and the special mode is a multi-play game mode.

Furthermore, in the case where the story mode is selected by the player, first, a transition to a class selection phase occurs, in which a player input with which the player selects one of the eight kinds of classes from class A to class H is accepted.

Specifically, in the class selection phase in the story mode, although not shown, a leader selection image including eight leader buttons, namely, leader button A in which leader character A is displayed to leader button H in which leader character H is displayed, is displayed in the display area 200. Then, when one of the leader buttons is tapped in the leader selection image, this operation is accepted as a player input for selecting the class corresponding to the leader character displayed in the tapped leader button. Then, the class selected by the player is set as the class of the player.

Then, a transition to a deck selection and construction phase occurs, in which a player input with which the player selects one of the plurality of kinds of decks corresponding to the class selected by the player, or a player input with which the player selects constructing a new custom deck is accepted.

Specifically, in the deck selection and construction phase in the story mode, although not shown, a deck selection image is displayed in the display area 200, which includes a default deck button for selecting a default deck corresponding to the class selected by the player, a constructed deck button for selecting a constructed deck corresponding to the class selected by the player, a custom deck button for selecting a custom deck corresponding to the class selected by the player, and a new construction button for selecting constructing a new custom deck. Furthermore, when one of the deck buttons is tapped in the deck selection image, this operation is accepted as a player input for selecting the deck corresponding to the tapped deck button. Then, the deck selected by the player is set as the deck of the player.

Then, a transition to a battle start phase occurs, in which a battle against a CPU player is started.

Meanwhile, when the new construction button is tapped in the deck selection image, this operation is accepted as a player input with which the player selects constructing a new custom deck. Then, although not shown, a custom deck construction image for constructing a custom deck corresponding to the class selected by the player is displayed in the display area 200. Furthermore, when a new custom deck is constructed by the player in the custom deck construction image, the deck selection image is displayed with an added custom deck button for selecting the custom deck newly constructed by the player.

Furthermore, in the case where the battle mode is selected by the player, first, a transition to the deck selection and construction phase occurs, in which a player input with which the player selects one of the plurality of kinds of decks individually corresponding to the eight kinds of classes from class A to class H, or a player input with which the player selects constructing a new custom deck, is accepted.

Specifically, in the deck selection and construction phase in the battle mode, although not shown, a deck selection screen is displayed in the display area 200, which includes eight default deck buttons, namely, default deck button A for selecting default deck A to default deck button H for selecting default deck H, a custom deck button for selecting a custom deck constructed by the player irrespective of the class, and a new construction button, but a constructed deck button is not displayed. Furthermore, when one of the deck buttons is tapped in the deck selection image, this operation is accepted as a player input for selecting the deck corresponding to the tapped deck button.

Here, in the deck selection and construction phase in the battle mode, when a player input for selecting a deck is accepted, the deck selected by the player is set as the deck of the player, and the class corresponding to the deck selected by the player is set as the class of the player. Therefore, in the deck selection and construction phase in the battle mode, a player input for selecting a deck is also accepted as a player input for selecting a class.

Then, a transition to the battle start phase occurs, in which a battle against another player is started.

Meanwhile, when the new construction button is tapped in the deck selection image, this operation is accepted as a player input with which the player selects constructing a new custom deck. Then, although not shown, a custom deck construction image is displayed in the display area 200. When a new custom deck is constructed by the player in the custom deck construction image, a deck selection image is displayed with an added custom deck button for selecting the custom deck newly constructed by the player.

Furthermore, in the case where the challenge mode is selected by the player, first, a transition to a class selection phase occurs, in which a player input with which the player selects one of the eight kinds of classes from class A to class H is accepted.

Specifically, in the class selection phase in the challenge mode, although not shown, a leader selection image similarly to the one in the class selection phase in the story mode, described earlier, is displayed in the display area 200. Then, when one of the leader buttons is tapped in the leader selection image, this operation is accepted as a player input for selecting the class corresponding to the leader character displayed in the tapped leader button. Furthermore, the class selected by the player is set as the class of the player.

Then, in the challenge mode, a transition to a deck construction phase occurs, in which a player input for constructing a deck in the challenge mode from the plurality of kinds of cards corresponding to the class selected by the player is accepted.

Specifically, in the deck construction phase in the challenge mode, although not shown, a challenge deck construction image for constructing a deck in the challenge mode is displayed in the display area 200, and a player input with which the player selects a card to be added to the deck among cards determined by a lottery from the plurality of kinds of cards corresponding to the class selected by the player is accepted. Furthermore, when a deck in the challenge mode is constructed by the player in the challenge deck construction image, the constructed deck in the challenge mode is set as the deck of the player.

Then, a transition to the battle start phase occurs, in which a battle against another player is started.

As described above, in the story mode, the battle mode, and the challenge mode in this embodiment, before a battle is started, a deck is constructed by selecting 40 cards from a large number of kinds of cards or one deck is selected from a large number of kinds of decks.

Here, in a card game like the one in this embodiment, an important element in the card game is which combination of cards is selected for a deck by the player or how cards are combined by the player to construct a deck. However, there is a problem in that some players feel it difficult or laborious to select one of a large number of kinds of decks including different kinds of cards or to construct a deck from a large number of kinds of cards.

However, in the case where a player selects a deck from a plurality of different kinds of decks constructed in advance, like default decks or constructed decks, there is a problem in that advantages and disadvantages may arise before a battle is started depending on the combination of the deck selected by the player and the deck selected by the opponent, and there is also a problem in that players get bored with decks constructed in advance.

Thus, in this embodiment, the special mode shown in FIG. 7 is provided. In the special mode, it is possible to casually start a battle without having to select one deck from a large number of kinds of decks including different kinds of cards or having to construct a deck from a large number of kinds of cards. Furthermore, a card game is executed such that it is possible to start a battle appropriately without advantages and disadvantages arising before the battle is started.

Specifically, as shown in FIG. 7, in the case where the special mode is selected by the player, first, a transition to a special deck selection phase occurs, in which a player input with which the player selects one special deck from special decks individually corresponding to the eight kinds of classes from class A to class H is accepted.

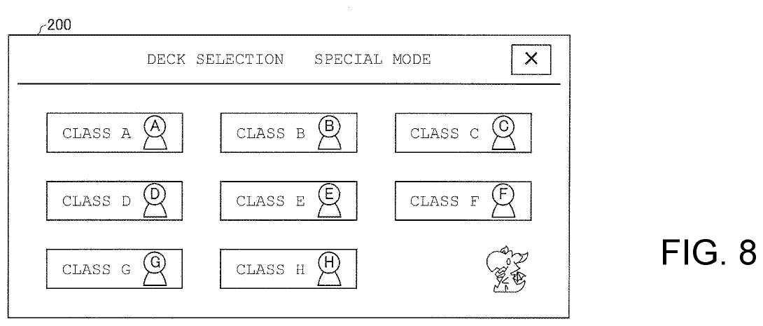

Specifically, in the special deck selection phase, as shown in FIG. 8, eight special deck buttons, namely, special deck button A for selecting special deck A corresponding to class A to special deck button H for selecting special deck H corresponding to class H, are displayed in the display area 200, but a default deck button, a constructed deck button, a custom deck button, or a new construction button is not displayed. Furthermore, when one of the special deck buttons is tapped in the special deck selection image, this operation is accepted as a player input for selecting the special deck corresponding to the tapped special deck button.

Here, in this embodiment, as shown in FIG. 8, in each of special deck button A to special deck button H, the name of the class corresponding to the special deck selected via the special deck button, as well as the leader character for the class, are displayed. Furthermore, in the special deck selection phase, when a player input for selecting a special deck is accepted, the special deck selected by the player is set as the deck of the player, and the class corresponding to the deck selected by the player is set as the class of the player. Therefore, in the special deck selection phase, a player input for selecting a special deck is also accepted as a player input for selecting a class.

Then, a transition to the battle start phase occurs, in which a battle against another player is started.

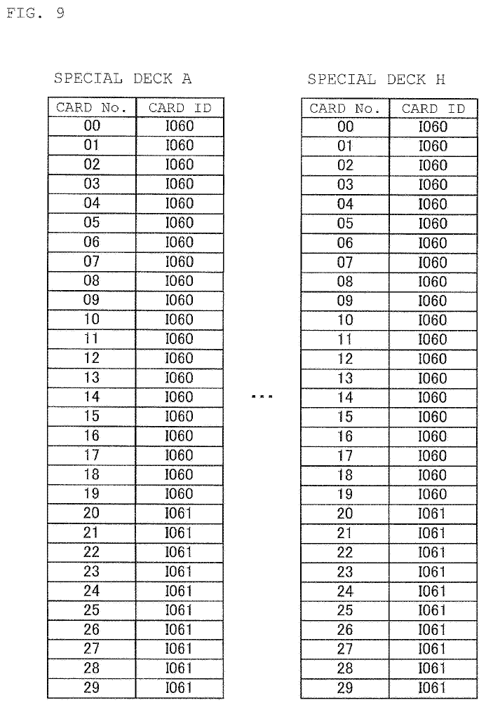

FIG. 9 shows eight kinds of special decks from special deck A corresponding to class A to special deck H corresponding to class H. As shown in FIG. 9, special deck A includes 30 cards with card number 00 to card number 29, the card IDs individually corresponding to card number 00 to card number 19 are all I060, and the card IDs individually corresponding to card number 20 to card number 29 are all I061, . . . , and special deck H includes 30 cards with card number 00 to card number 29, the card IDs individually corresponding to card number 00 to card number 19 are all I060, and the card IDs individually corresponding to card number 20 to card number 29 are all I061. That is, special deck A includes 30 cards shared among classes in total, including 20 cards with the card ID I060 and 10 cards with the card ID I061, . . . and special deck H also includes 30 cards shared among classes in total, including 20 cards with the card ID I060 and 10 cards with the card ID I061.

Here, in the shared master list shown in FIG. 5, the card name of the card with the card ID I060 is a first special card (special game medium), and the card name of the card with the card ID I061 is a second special card (special game medium). Furthermore, although not shown, the card with the card ID I060 and the card with the card ID I061, i.e., the first special card and the second special card, are classified as spell cards. With these cards, the cost is zero, no attacking ability or physical energy is set, the effect is adding two cards determined by a lottery from the plurality of kinds of cards corresponding to the class of the player to the hand, and the effect generation condition (special condition) and the removal condition are to place those cards in the field from the hand.

That is, each of the eight kinds of special decks includes 30 spell cards in total, including 20 first special cards and 10 second special cards, and the eight individual kinds of special decks have the same content.

As described above, in the special mode, regardless of which of special deck button A to special deck button H shown in FIG. 8 is tapped in the special deck selection phase shown in FIG. 7, a special deck having the same content is set as the deck of the player.

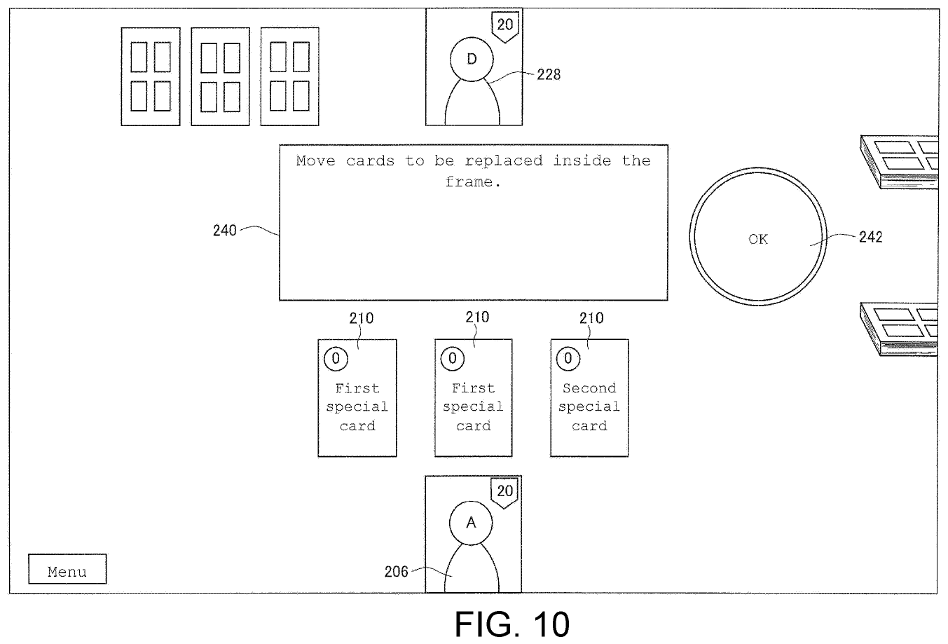

FIG. 10 is a figure showing an example game image displayed in the display area 200 in the special mode. In this embodiment, also in the special mode, similarly to the other game modes, in the case where a battle is started, first, three cards are determined as candidates for the initial hand by a lottery from the cards included in the special deck for each of the player at the local terminal and the opponent.

Specifically, for each of the special deck of the player at the local terminal and the special deck of the opponent, three card numbers are determined as candidate card numbers for the initial hand by a lottery from the 30 card numbers of the respective special decks. In this manner, in this embodiment, when a deck is set as the deck of the player, the cards included in the deck are managed on the basis of card numbers in the deck.

Then, as shown in FIG. 10, on the basis of the three card numbers determined by the lottery, card images 210 for the three candidates for the initial hand are displayed above the local-terminal leader image 206. In the example in FIG. 10, of the three card numbers determined by the lottery, the card IDs corresponding to two card numbers are I060, and the card ID corresponding to one card number is I061. Thus, of the card images 210 for the three candidates for the initial hand, the first card image 210 from the left and the second card image 210 from the left are card images 210 for first special cards, and the third card image 210 from the left is a card image 210 for a second special card. Furthermore, in each of the card images 210 of the first special cards and the card image 210 of the second special card, a cost indication 214 indicates zero, but an attacking ability indication 216 or a physical energy indication 208 is not displayed.

Here, in the example in FIG. 10, since leader character A corresponding to class A is displayed as the local-terminal leader image 206, special deck A is set as the deck of the player at the local terminal, and since leader character D corresponding to class D is displayed as the opponent leader image 228, special deck D is set as the deck of the opponent. However, as described earlier, special deck A and special deck D have the same content and include only first special cards and second special cards. Thus, for both the player at the local terminal and the opponent, three candidates for the initial hand are determined to be first special cards or second special cards.

Furthermore, above the card images 210 for the three candidates for the initial hand, a replacement area 240 into which a card to be replaced with another card is moved, and an OK button 242 is displayed on the right side of the replacement area 240. Furthermore, when the player at the local terminal taps the OK button 242 without moving any of the card images 210 for the three candidates for the initial hand into the replacement area 240, this operation is accepted as a player input for selecting not replacing any of the three cards serving as the candidates for the initial hand with another card. Then, the three cards serving as the candidates for the initial hand of the player at the local terminal are set as they are as the initial hand of the player at the local terminal.

Specifically, the three card numbers determined by a lottery as the card numbers of the candidates for the initial hand are set as the card numbers of the initial hand.

Meanwhile, when the player at the local terminal moves any of the card images 210 for the three candidates for the initial hand into the replacement area 240 and taps the OK button 242, this operation is accepted as a player input for selecting replacing the card or cards corresponding to the card image or card images 210 moved into the replacement area 240 with another card or other cards. Then, the same number of cards as the number of cards selected for replacement are determined by another lottery from the cards remaining after excluding the three cards serving as the candidates for the hand of the player from the cards included in special deck A of the player at the local terminal. Then, in the case where cards determined by another lottery and cards not selected for replacement exist, the cards serving as the candidates for the initial hand, not selected for replacement, are set as the initial hand of the player at the local terminal.

Specifically, the same number of card numbers as the number of cards selected for replacement are determined by another lottery from the card numbers remaining after excluding the three card numbers determined by a lottery as the card numbers of the candidates for the initial hand among the 30 card numbers of special deck A of the player at the local terminal. Then, in the case where card numbers determined by another lottery and cards not selected for replacement exist, the card numbers of the candidates for the initial hand, not selected for replacement, are set as the card numbers of the initial hand of the player at the local terminal.

For example, when the third card image 210 from the left for a second special card among the three card images 210 for the candidates for the initial hand is moved into the replacement area 240 and the OK button 242 is tapped, one card is determined by another lottery from the cards remaining after excluding the two first special cards and one second special card serving as the candidates for the hand of the player from the cards included in special deck A of the player at the local terminal.

Then, the one first special card or second special card determined by another lottery and the two cards not selected for replacement are set as the initial hand of the player at the local terminal.

Specifically, one card number is determined by another lottery from the card numbers remaining after excluding the three card numbers determined by a lottery as the card numbers of the candidates for the initial hand among the 30 card numbers of special deck A of the player at the local terminal. Furthermore, the one card number determined by another lottery and the card numbers corresponding to the two cards not selected for replacement are set as the card numbers of the initial hand of the player at the local terminal.

Note that, in the special mode, since a special deck includes only first special cards and second special cards, a first special card or a second special card is determined by another lottery.

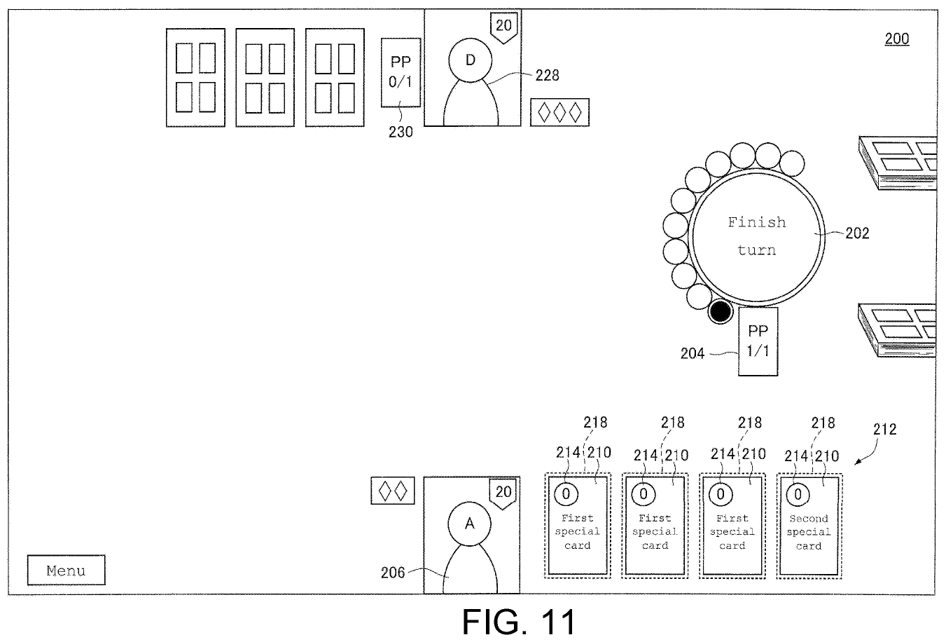

Then, as shown in FIG. 11, the replacement area 240 and the OK button 242 are erased, the turn finish button 202, the local-terminal PP indication 204, the opponent PP indication 230, etc. are displayed, and the card images 210 for the three cards set as the initial hand of the player at the local terminal are displayed in the local-terminal hand area 212. Furthermore, in the example in FIG. 11, since the player at the local terminal is the first player, one card is added to the hand of the player at the local terminal in the first turn, and thus four card images 210 in total are displayed in the local-terminal hand area 212.

In the example in FIG. 11, of the four card images 210 displayed in the local-terminal hand area 212, the first to third card images 210 from the left are the card images 210 for the three cards set as the initial hand. However, since one first special card is determined by another lottery, as described above, and one second special card is replaced therewith, the card images 210 for the three cards set as the initial hand are all card images 210 for first special cards.

Furthermore, the fourth card image 210 from the left is the card image 210 corresponding to the card added to the hand of the player at the local terminal in the first turn. Since the card added to the hand of the player at the local terminal in the first turn is a second special card, the card image 210 for the card added to the hand of the player at the local terminal in the first turn is a card image 210 for the second special card.

Furthermore, in the example in FIG. 11, the currently remaining play points of the player at the local terminal are one point, and the cost indication 214 of each of the three card images 210 for the first special cards and the one card image 210 for the second special card, displayed in the local-terminal hand area 212, indicate zero. Thus, a play enabled indication 218 is displayed in each of the three card images 210 for the first special cards and the one card image 210 for the second special card, displayed in the local-terminal hand area 212. That is, in this embodiment, it is possible to place a first special card or a second special card in the field irrespective of the currently remaining play points.

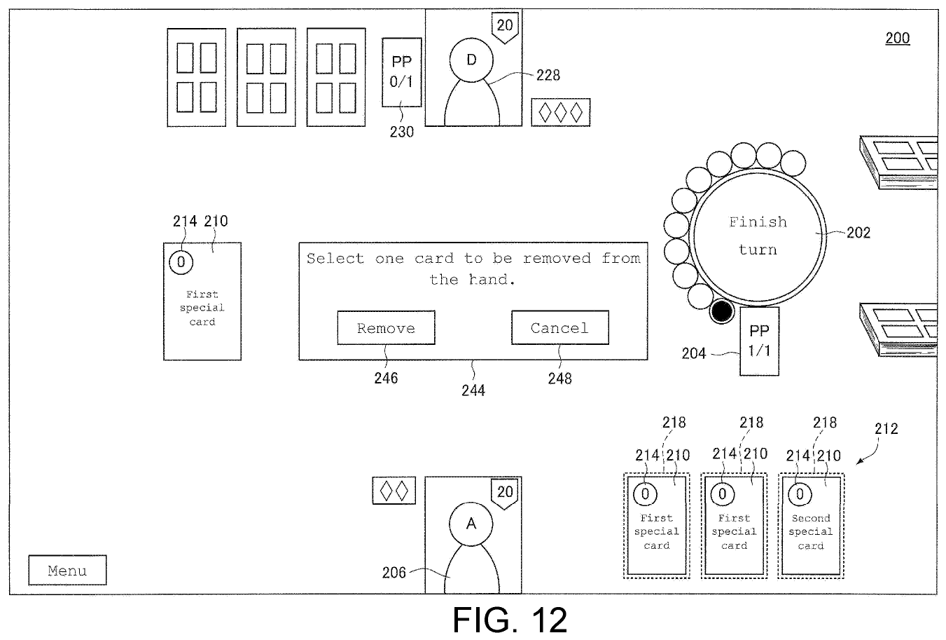

Furthermore, upon the acquisition of a player input for placing in the field one of the card images 210 for the first special cards and the card image 210 for the second special card in which play enabled indications 218 are displayed in the local-terminal hand area 212, the first special card or second special card for which the player input for placing the card in the field is acquired is set in a wait state, in which effect generation is awaited. Furthermore, the card image 210 of the first special card or second special card set in the wait state is displayed at a wait position set in a left middle part of the display area 200, as shown in FIG. 12, and a removed card selection image 244 is displayed in a central part of the display area 200, which indicates that one card to be removed from the hand is to be selected.

Furthermore, in the case where a first special card or a second special card is in the wait state, when one of the card images 210 displayed in the local-terminal hand area 212 is tapped, a remove button 246 displayed in the removed card selection image 244 is enabled, and when the enabled remove button 246 is tapped, this operation is acquired as a player input for selecting the tapped one card image 210 as a card to be removed.

Then, the card image 210 for the first special card or the card image 210 for the second special card in the wait state is removed, and the card image 210 for which the player input for selecting a card as a card to be removed is acquired is removed. Furthermore, as the effect of the first special card or second special card in the wait state, a special lottery for determining two cards from the plurality of kinds of cards corresponding to the class of the player at the local terminal is executed, and the two cards determined by the special lottery are added to the hand of the player at the local terminal.

Meanwhile, in the case where a first special card or a second special card is in the wait state, when a cancel button 248 displayed in the removed card selection image 244 shown in FIG. 12 is tapped, the wait state of the first special card or the second special card is cancelled. Then, the removed card selection image 244 is erased, and the card image 210 of the first special card or second special card in the wait state is displayed so as to return from the wait position to the local-terminal hand area 212.

Furthermore, in this embodiment, in the case where the card image 210 displayed in the local-terminal hand area 212 is only one card image 210 for a first special card or one card image 210 for a second special card, when the one card image 210 for the first special card or the second special card is placed in the field, there is no more card image 210 displayed in the local-terminal hand area 212, and then it is not possible to select a card to be removed from the hand. Thus, it is not allowed to place in the field the one card image 210 for the first special card or second special card.

As described above, in the special mode in this embodiment, when two cards in total, namely, a first special card or a second special card placed in the field and a card selected by the player among the cards set as the hand, are removed, two cards for individual classes, determined by a special lottery, are added to the hand.

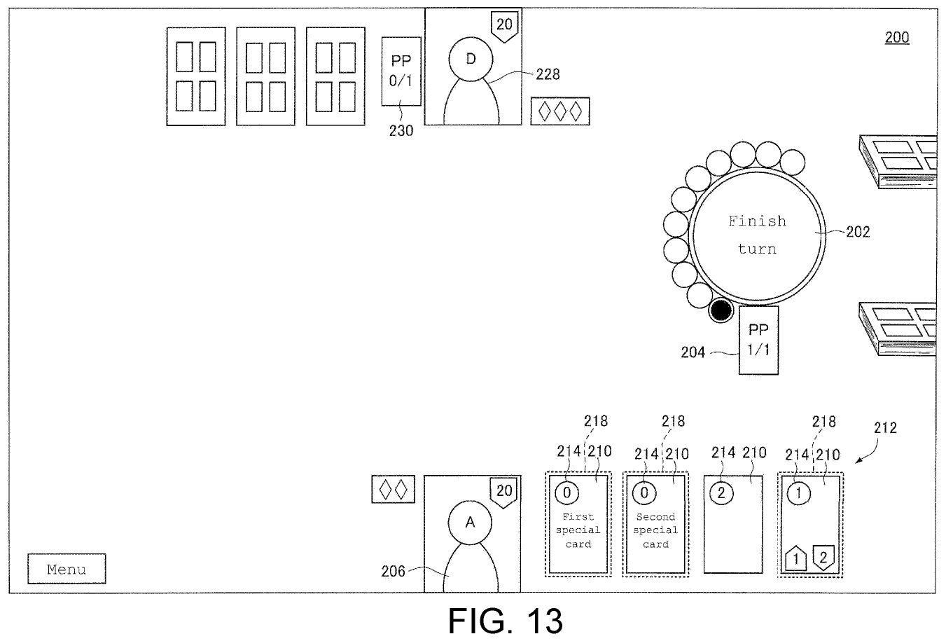

In the example in FIG. 13, of the four card images 210 displayed in the local-terminal hand area 212, the third and fourth card images 210 from the left are the card images 210 corresponding to the two cards determined by the special lottery. The third card image 210 from the left is a card image 210 for an amulet card, and the fourth card image 210 from the left is a card image 210 for a follower card.

Furthermore, in the example in FIG. 13, the currently remaining play points of the player at the local terminal are one point. The cost indication 214 of the third card image 210 from the left for the amulet card is two, and thus a play enabled indication 218 is not displayed therein. The cost indication 214 of the fourth card image 210 from the left for the follower card indicates one, and thus a play enabled indication 218 is displayed therein.

Furthermore, in the example in FIG. 13, since the class of the player at the local terminal is class A, the two cards determined by the special lottery are both cards for class A.

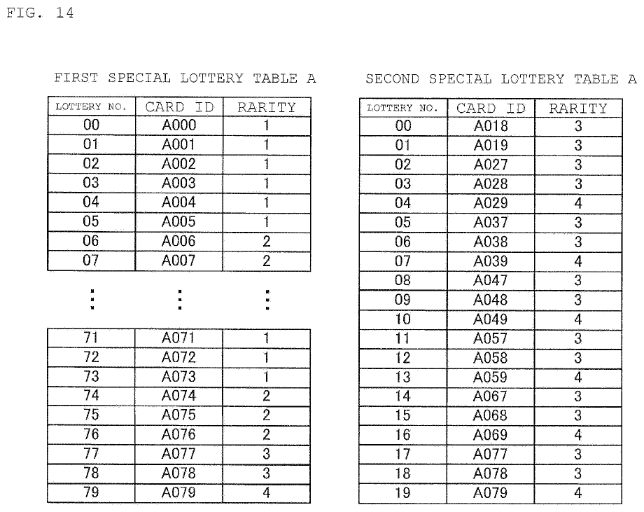

FIG. 14 is a figure showing an example of special lottery tables (game medium groups) that are referred to in the special lottery. Referring to FIG. 14, first special lottery table A is a special lottery table that is referred to in the case where the class of the player is class A and a first special card is placed in the field, and second special lottery table A is a special lottery table that is referred to in the case where the class of the player is class A and a second special card is placed in the field. Furthermore, in first special lottery table A, all the 80 kinds of cards for class A, set in master list A shown in FIG. 5, are set as lottery items. Meanwhile, in second special lottery table A, of the cards for class A, set in master list A shown in FIG. 5, cards having high rarity are set as lottery items.

Furthermore, in this embodiment, the server information storage medium 20 stores eight kinds of first special lottery tables and eight kinds of second special lottery tables, namely, first special lottery table A and second special lottery table A corresponding to class A to first special lottery table H and second special lottery table H corresponding to class H. Furthermore, the hit probabilities of the individual lottery items are set to be the same among the individual eight kinds of first special lottery tables and eight kinds of second special lottery tables.

Thus, in this embodiment, the two cards determined by the special lottery both become cards corresponding to the class of the player, and any card corresponding to the class of the player has a possibility of being added to the hand through the special lottery. Furthermore, the rarity of a card that is added to the hand is higher in the case where a second special card is placed in the field than in the case where a first special card is placed in the field.

As described above, in the special mode in this embodiment, since a special deck having the same content is set as the deck of a player, it is possible to casually start a battle without having to select one deck from a large number of kinds of decks or having to construct a deck from a large number of kinds of cards, and it is possible to start a battle appropriately without advantages and disadvantages arising even before the battle is started. Furthermore, it is possible to proceed with the game by placing the card determined by the special lottery and added to the hand.

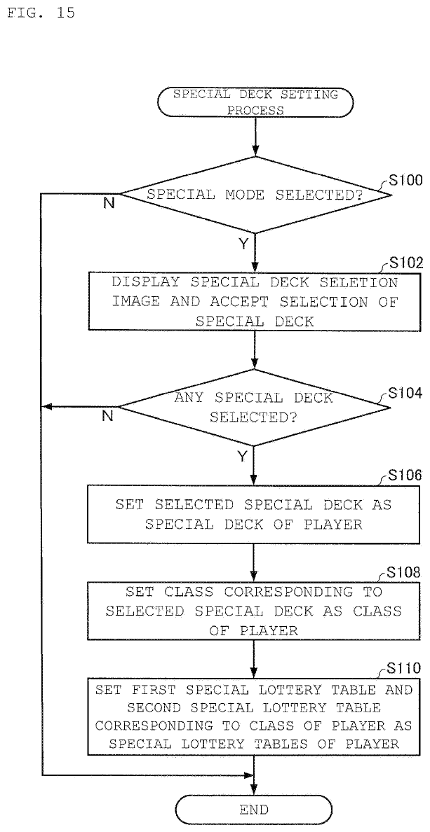

The following describes the flows of processes that are executed at the server device 12 in this embodiment with reference to flowcharts in FIGS. 15 to 18.

In a special deck setting process shown in FIG. 15, first, when the special mode is selected (Y in step S100), the mode processing unit 43 displays a special deck selection image to accept the selection of a special deck (step S102). Then, when a special deck is selected (Y in step S104), the deck processing unit 45 sets the selected special deck as the special deck of the player (step S106), and the class processing unit 44 sets the class corresponding to the selected special deck as the class of the player (step S108). Then, the card processing unit 47 sets the first special lottery table and the second special lottery table corresponding to the class of the player as the special lottery tables of the player (step S110).

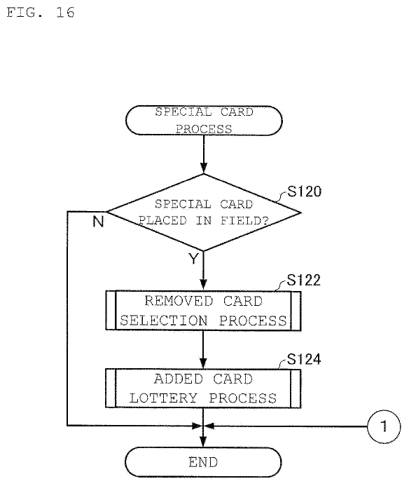

In a special card process shown in FIG. 16, the card processing unit 47, upon accepting a player input for placing a special card in the field (Y in step S120), executes a removed card selection process (step S122) and executes an added card lottery process (step S124).

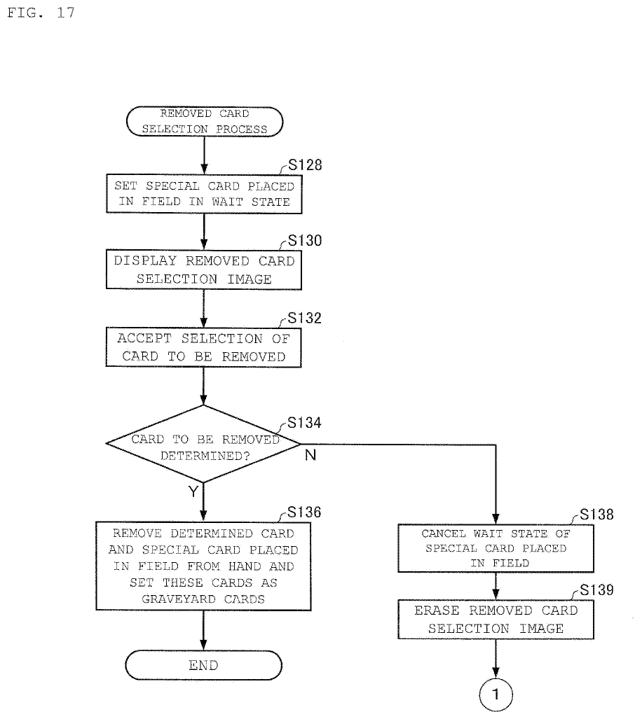

Specifically, in the removed card selection process in step S122 shown in FIG. 16, as shown in FIG. 17, the card processing unit 47 sets the special card placed in the field in the wait state (step S128). Furthermore, a removed card selection image is displayed (step S130), and the selection of a card to be removed is accepted (step S132). When a card to be removed is determined (Y in step S134), the determined card and the special card placed in the field are removed from the hand and are set as graveyard cards (step S136). Meanwhile, when the cancel button 248 displayed in the removed card selection image 244 is tapped or upon the elapse of 90 seconds, which is the time limit for one turn, and thus a card to be removed is not determined (N in step S134), the wait state of the special card placed in the field is cancelled (step S138), the removed card selection image is erased (step S139), and the special card process is finished without executing the added card lottery process in step S124 shown in FIG. 16.

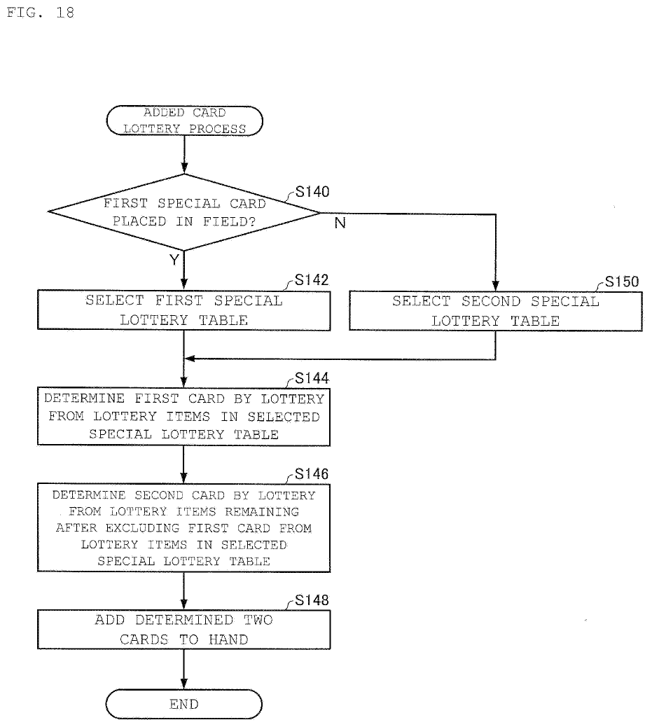

Furthermore, in the added card lottery process in step S124 shown in FIG. 16, as shown in FIG. 18, in the case where the special card placed in the field is a first special card (Y in step S140), the card processing unit 47 selects a first special lottery table (step S142), determines the first card by a lottery from the lottery items in the first special lottery table (step S144), and determines the second card by a lottery from the lottery items remaining after excluding the first card from the lottery items in the first special lottery table (step S146). Then, the card processing unit 47 adds the determined two cards to the hand (step S148). Meanwhile, in the case where the special card placed in the field is a second special card (N in step S140), the card processing unit 47 selects a second special lottery table (step S150), determines the first card by a lottery from the lottery items in the second special lottery table (step S144), and determines the second card by a lottery from the lottery items remaining after excluding the first card from the lottery items in the second special lottery table (step S146). Then, the card processing unit 47 adds the determined two cards to the hand (step S148).

### 3. Modifications

The present invention can be modified and embodied in various forms, without limitation to the embodiment described above. The following introduces modifications. Note that the embodiment described above and various methods described below as modifications can be adopted in combinations as appropriate as methods for realizing the present invention.

First, although the above-described embodiment has been described in the context of an example where one leader character exists for one class, two or more leader characters may exist for one class. Furthermore, in this case, a player may select one class from a plurality of classes and may then select one leader character from the plurality of leader characters belonging to the selected one class, or when the player selects one leader character from the plurality of characters, the class of the selected one leader character may be set as the class of the player.

Furthermore, although the above-described embodiment has been described in the context of an example where a player selects a class, the class of a player may be determined according to a prescribed condition, such as a lottery, for example, when the game is started.

Furthermore, although the above-described embodiment has been described in the context of an example where master lists include per-class master lists and a shared master list, master lists may include either per-class master lists or a shared master list. Furthermore, a shared master list may be created by extracting or combining card information included in the per-class master lists, or per-class master lists may be created by extracting or combining card information included in the shared master list.

Furthermore, although the above-described embodiment has been described in the context of an example where the special mode is a multi-play game mode, the special mode may be a solo-play game mode, or a player may be allowed to select a multi-play special mode or a solo-play special mode.

Furthermore, although the above-described embodiment has been described in the context of an example where a player selects one special deck from a plurality of special decks in the special mode, the configuration may be such that when a player selects one class from a plurality of kinds of classes, the selected class is set as the class of the player, and one special deck shared among individual classes is set as the deck of the player, or the configuration may be such that when a player selects one leader character from a plurality of kinds of leader characters, a class corresponding to the selected leader character is set as the class of the player, and one special deck shared among individual classes is set as the deck of the player.

Furthermore, although the above-described embodiment has been described in the context of an example where the individual eight kinds of special decks have the same content, the content of the individual eight kinds of special decks may vary; for example, among the individual eight kinds of special decks, the ratio between first special cards and second special cards may vary, or some special decks may include third special cards for which special lottery tables different from those for first special cards and second special cards are referred to.

Furthermore, although the above-described embodiment has been described in the context of an example where each of the eight kinds of special decks includes only first special cards and second special cards, at least one of the eight kinds of special decks may include at least one type of cards (non-special game media) among follower cards, amulet cards, and spell cards that are different from first special cards and second special cards.

Furthermore, in the above-described embodiment, in the first turn for the first player, three cards are set as the initial hand, and as a result of adding one card to the hand, four cards are set as the hand, whereas in the first turn for the second player, three cards are set as the initial hand, and as a result of adding two cards to the hand, five cards are set as the hand. Thus, a prescribed number of cards, the number being less than or equal to three, that are different from first special cards and second special cards may be included in a special deck. That is, for either the first player or the second player, a special deck may include a number of different cards that do not prohibit a first special card or a second special card from being set as the hand in the first turn.

Furthermore, although the above-described embodiment has been described in the context of an example where the effect generation condition for first special cards and second special cards is “being placed in the field from the hand”, various conditions may be set as the effect generation conditions for first special cards and second special cards, such as “when added to the hand”, “when removed”, “when attacking”, “when being attacked”, and “when a prescribed condition for the other cards in the hand is satisfied”. Furthermore, the effects of first special cards and second special cards may be exhibited in the form of monsters or may be invoked in the form of skills of leader characters.

Furthermore, the above-described embodiment has been described in the context of an example where the effect of first special cards and second special cards varies depending on the class of the player; for example, the effect of first special cards and second special cards is to add two cards for class A to the hand in the case where the class of the player is class A, and to add two cards for class B to the hand in the case where the class of the player is class B. However, special cards having different effects may be included in special decks corresponding to individual classes; for example, in the case where the class of the player is class A, special deck A is set as the deck of the player, and special deck A includes special card A having an effect of adding two cards for class A to the hand, and in the case where the class of the player is class B, special deck B is set as the deck of the player, and special deck B includes special card B having an effect of adding two cards for class B to the hand.

Furthermore, although the above-described embodiment has been described in the context of an example where the server information storage medium 20 stores eight kinds of first special lottery tables and eight kinds of second special lottery tables, namely, first special lottery table A and second special lottery table A corresponding to class A to first special lottery table H and second special lottery table H corresponding to class H, a special lottery table may be created each time a special lottery is executed on the basis of the master list corresponding to the class of the player. In this case, the configuration may be such that a first special lottery table is created on the basis of a master list corresponding to the class of the player when a player input for placing a first special card in the field is acquired and such that a second special lottery table is created on the basis of a master list corresponding to the class of the player when a player input for placing a second special card in the field is acquired.

Furthermore, although the above-described embodiment has been described in the context of an example where two cards determined by a special lottery are added to the hand of the player, two cards determined by a special lottery may be added to the deck of the player. Alternatively, of the two cards determined by a special lottery, one may be added to the hand, and the other may be added to the deck. Alternatively, the player may be allowed to determine the destination of addition.

Furthermore, although the above-described embodiment has been described in the context of an example where two cards determined by a special lottery are different cards, there may be cases where two cards determined by a special lottery are the same card.

Furthermore, although the above-described embodiment has been described in the context of an example where all the cards for each class are set as lottery items in special lottery tables for that class, cards shared among all the classes or cards shared among some of the classes may be set as lottery items.

Furthermore, although the above-described embodiment has been described in the context of a case where two cards are determined by a special lottery, two cards may be extracted from a list according to a prescribed condition, or two cards may be determined by using a pseudo-random number.

What is claimed is:

1. A non-transitory computer-readable information storage medium storing a program for running a game on the basis of game media included in a game medium group associated with a player and game media included in a game medium group associated with an opponent, the program causing a computer to function as:
a type processing unit that associates one of a plurality of types with the player;
a game-medium-group processing unit that associates a game medium group including a plurality of special game media with the player; and
a game-medium processing unit that determines a game medium from the game medium group corresponding to the type associated with the player and adds the determined game medium to the game medium group associated with the player in the case where a special condition corresponding to a special game medium is satisfied.

2. The information storage medium according to claim 1, wherein:
the game-medium-group processing unit associates a game medium group including a plurality of kinds of special game media with the player, and
the game-medium processing unit determines a game medium according to a condition corresponding to the kind of special game medium for which the special condition is satisfied.

3. The information storage medium according to claim 1, wherein:
in the case where the special condition is satisfied, the game-medium processing unit executes processing for decreasing the number of game media that can be selected by the player from the game medium group associated with the player.

4. The information storage medium according to claim 1, wherein:
the game-medium-group processing unit associates a game medium group including only special game media with the player.

5. The information storage medium according to claim 1, wherein:
in the case where the game is started, the game-medium processing unit determines a prescribed number of game media as game media that can first be selected by the player from the game medium group associated with the player, and
the game-medium-group processing unit associates a game medium group including a plurality of special game media and a number of non-special game media with the player, where the number is greater than or equal to zero and is less than the prescribed number.

6. A server for running a game on the basis of game media included in a game medium group associated with a player and game media included in a game medium group associated with an opponent, the server comprising:
a type processing unit that associates one of a plurality of types with the player;
a game-medium-group processing unit that associates a game medium group including a plurality of special game media with the player; and
a game-medium processing unit that determines a game medium from the game medium group corresponding to the type associated with the player and adds the determined game medium to the game medium group associated with the player in the case where a special condition corresponding to a special game medium is satisfied.

7. A game system for running a game on the basis of game media included in a game medium group associated with a player and game media included in a game medium group associated with an opponent, the game system comprising:
a type processing unit that associates one of a plurality of types with the player;
a game-medium-group processing unit that associates a game medium group including a plurality of special game media with the player; and
a game-medium processing unit that determines a game medium from the game medium group corresponding to the type associated with the player and adds the determined game medium to the game medium group associated with the player in the case where a special condition corresponding to a special game medium is satisfied.
